(19) United States
(12) Patent Application Publication
(10) Pub. No.: US 2014/0378036 A1
(43) Pub. Date: Dec. 25, 2014

(54) ABRASIVE ARTICLE AND METHOD OF MAKING SAME

(71) Applicants: Saint-Gobain Abrasives, Inc., Worcester, MA (US); Saint-Gobain Abrasifs, Conflans-Sainte-Honorine (FR)

(72) Inventors: Tyler B. Cichowlas, Sudbury, MA (US); Michael W. Klett, Holden, MA (US)

(21) Appl. No.: 14/314,818

(22) Filed: Jun. 25, 2014

Related U.S. Application Data
(60) Provisional application No. 61/839,076, filed on Jun. 25, 2013.

(51) Int. Cl. C09K 3/14; B24D 18/00; B24D 11/00

(52) U.S. Cl. CPC C09K 3/1436; B24D 11/001; B24D 11/00; B24D 18/00
USPC 451/533; 451/526; 451/540; 51/307

(57) ABSTRACT

An abrasive article may include an abrasive body having a grinding layer, where the grinding layer may include a bond and abrasive particles contained within the bond. The abrasive body also may include a volumetric ratio GLV_{b}/GLVₐₚ of at least about 0.4, where GLV_{b} is a volume percent of bond for a total volume of the grinding layer and GLVₐₚ is a volume percent of abrasive particles for a total volume of the grinding layer. The abrasive particles may include seeded sol-gel ceramic and may have an average particle size of at least about 600 microns. In addition, the abrasive particles may include a coupling agent that may include an organic material with a silane functional group. Prior to formation of the abrasive article, the abrasive particles may be coated by the coupling agent at a ratio A_{COA}/A_{AB} of at least about 0.1, where C_{COA} is the amount of coupling agent in grams in a pre-formation mixture and A_{AB} is the amount of abrasive particles in pounds (lbs) in the pre-formation mixture.

### CROSS-REFERENCE TO RELATED APPLICATION(S)

The present application claims priority from U.S. Provisional Patent Application No. 61/839,076, filed Jun. 25, 2013, entitled “ABRASIVE ARTICLE AND METHOD OF MAKING SAME,” naming inventors Tyler B. Cichowlas and Michael W. Klett, which application is incorporated by reference herein in its entirety.

### BACKGROUND OF THE INVENTION

1. Field of the Disclosure

The present invention relates in general to abrasive articles and, in particular, to abrasive articles and a method of making them.

2. Description of the Related Art

Abrasive wheels are typically used for cutting, abrading, and shaping of various materials, such as stone, metal, glass, and plastics, among other materials. Generally, the abrasive wheels can have various phases of materials including abrasive grains or particles, a bonding agent, and some porosity. Depending upon the intended application, the abrasive wheel can have various designs and configurations. For example, for applications directed to the finishing and cutting of metals, some abrasive wheels are fashioned such that they have a particularly thin profile for efficient cutting.

However, given the application of such wheels, the abrasive articles are subject to fatigue and failure. In the case of thin wheel cutting systems, degradation includes a reduction in the amount of cutting that can be achieved before the thin wheeled abrasive wears out. In addition, degradation can include an increase in wear rate of the abrasive article or a reduction in grind rate on a work piece. Some wheels may have a limited time of use of less than a day depending upon the frequency of use. Accordingly, the industry continues to demand abrasive wheels capable of improved performance.

### SUMMARY

Embodiments of an abrasive article and method of manufacturing it are disclosed. For example, an abrasive article may include an abrasive body having a grinding layer. The grinding layer may include a bond and abrasive particles contained within the bond. The grinding layer also may include a volumetric ratio GLV_{b}/GLVₐₚ of at least about 0.4, where GLV_{b} is a volume percent of bond for a total volume of the grinding layer and GLVₐₚ is a volume percent of abrasive particles for a total volume of the grinding layer. The abrasive particles may include seeded sol-gel ceramic. The abrasive particles may have an average particle size of at least about 600.

In other embodiments of an abrasive article, the abrasive article may include an abrasive body having a grinding layer. The grinding layer may include a bond and abrasive particles. The abrasive particles may include seeded sol-gel ceramic having an average particle size of at least about 600 microns. In addition, the abrasive particles may include a coupling agent that may include an organic material. The organic material may include a silane functional group. In some embodiments, wherein, prior to formation of the abrasive article, the abrasive particles are coated by the coupling agent at a ratio A_{COA}/A_{AB} of at least about 0.1 g/lb, where C_{COA} is the amount of coupling agent in grams in a pre-formation mixture and A is the amount of abrasive particles in pounds (lbs) in a pre-formation mixture.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1A is a cross-section view of a wheel illustrated in accordance with an embodiment described herein.

FIG. 1B is a view of a patterned working (front) face of a wheel illustrated in accordance with an embodiment described herein.

FIG. 1C is a view of a working (front) face of a wheel illustrated in accordance with an embodiment described herein.

FIG. 1D is a view of a workpiece being processed by a wheel illustrated in accordance with an embodiment described herein.

FIGS. 2A through 2E are cross-sectional views of a portion of the flat region of a wheel illustrating various arrangements of abrasive layers and reinforcements in accordance with an embodiment described herein.

FIG. 3 is a plot of MRR versus WRR for embodiments of abrasive wheels described herein and a comparative abrasive wheel.

FIG. 4 is a plot of MRR versus WRR for embodiments of abrasive wheels described herein and other comparative abrasive wheels.

FIG. 5 is a graph of MRR for an embodiment of an abrasive wheel described herein and comparative abrasive wheels.

The use of the same reference symbols in different drawings indicates similar or identical items.

### DETAILED DESCRIPTION

In one aspect, the invention is directed to an abrasive article. The abrasive article may include a thin wheel tool having a body that may include abrasive particles contained within a bond material.

Further aspects of the invention relate to a method for using thin wheels such as those described herein. In one embodiment, a method for grinding a workpiece may include attaching a thin wheel tool as described herein to a grinding machine and rotating said thin wheel tool against a workpiece to grind said workpiece, where the thin wheel tool exhibits an increase in metal removal rate (MRR) with respect to a conventional wheel under the same grinding conditions. In another embodiment, a method for grinding a workpiece may include attaching a thin wheel tool as described herein to a grinding machine and rotating said thin wheel tool against a workpiece to grind said workpiece, where the thin wheel tool exhibits an increase in life span with respect to a conventional wheel under the same grinding conditions.

The corresponding conventional products can be an abrasive articles of the same specification as the wheel according to aspects of the invention. Wheel specifications are known in the art and are used to identify features such as wheel type, wheel composition, e.g., grain type, grit size, bond used, structure of the wheel, wheel hardness and so forth. Abrasive wheels also can be identified by their dimensions, manufacturer and/or other attributes, e.g., the presence or absence of reinforcement. In some implementations, the conventional wheel can be thought of as a wheel having a MRR and life span ordinarily associated with it, rather than the improved MRR and improved life span of a wheel of the invention.

### Thin Wheels

In specific implementations, the abrasive articles may include any suitable abrasive wheels. In an embodiment, the abrasive wheels may include depressed center wheels, such as, for example, ANSI (American National Standards Institute) Type 27, Type 28 or Type 29 wheels, or European Standard (EN 14312) Type 42 wheels. Still, essentially any thin wheel construction may be utilized with the present embodiments.

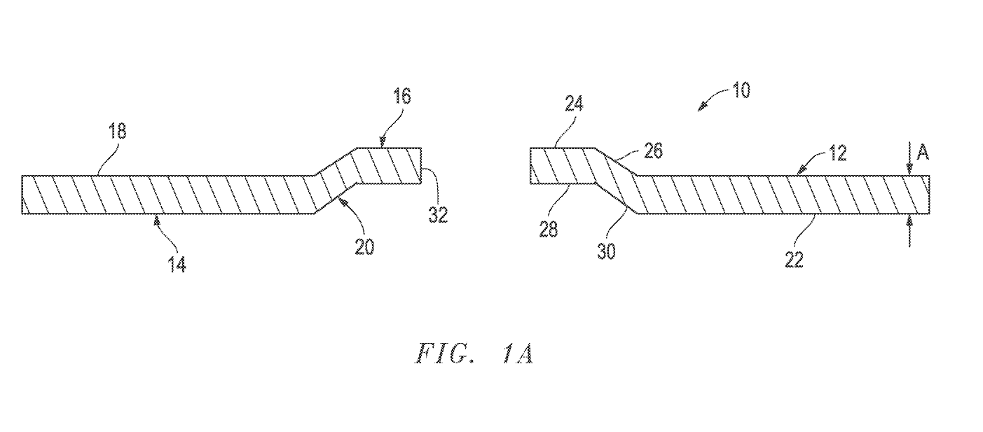

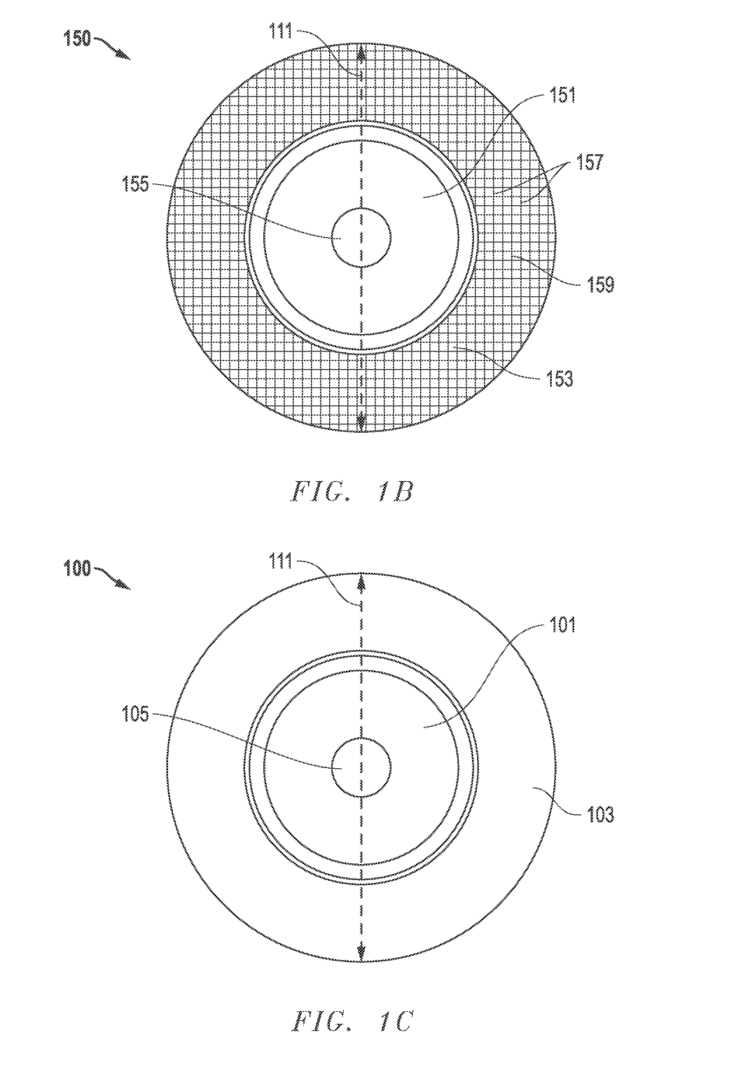

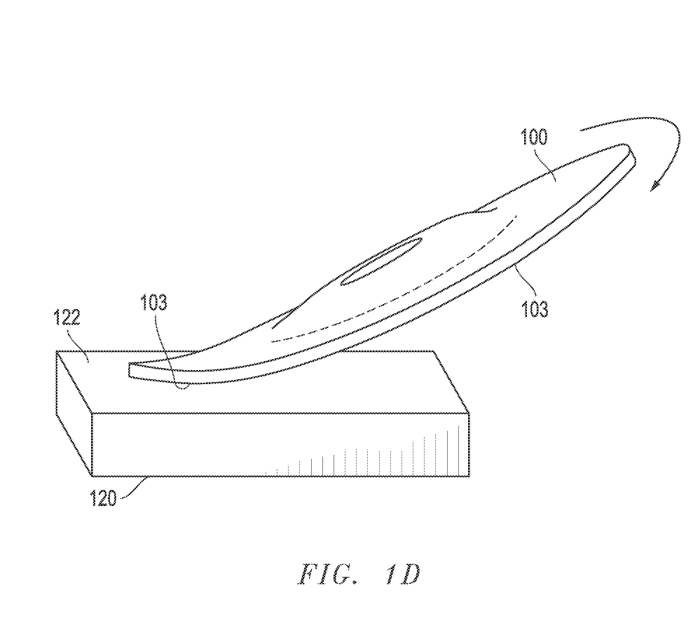

Shown in FIG. 1A, for instance, is a cross-sectional view of depressed center abrasive wheel 10 which may include a rear (top) face 12 and a front (bottom) face 14. The rear face 12 can include a raised hub region 16 and outer flat rear wheel region 18. The front face 14 can include a depressed center region 20 and outer flat front wheel region 22 (which provides the working surface of the wheel). In turn, raised hub region 16 has raised hub surface 24 and back sloping (or slanted) surface 26; depressed center region 20 may include depressed center 28 and front sloping (or slanted) surface 30. Wheel 10 has central opening 32 for mounting the wheel on the rotating spindle of a tool, e.g., a hand-held angle grinder. During operation, wheel 10 typically is secured by mounting hardware (not shown in FIG. 1A) such as, for instance, a suitable flange system. The wheel can also be part of an integrated arrangement that may include mounting hardware.

Wheel 10 can have a thickness “A” that can be measured at various positions, including at the periphery of the wheel. In many designs, the thickness of wheel 10 remains the same or essentially the same along a radial direction from the central opening to the outer edge (periphery) of the wheel. In other designs, the wheel thickness can vary (can increase or decrease) along a radial distance from the central opening to its periphery. For example, the body of wheel 10 can have a thickness A in a range of 0.8 mm to 20 mm, such as a range of 0.8 mm to 15 mm, or even a range of 0.8 mm to 10 mm. In particular, the body of wheel 10 can include a thickness A of at least about 0.8 mm, such as, at least about 0.9 mm, at least about 1 mm, at least about 1.2 mm, at least about 1.3 mm, at least about 1.5 mm, at least about 1.8 mm, at least about 2 mm, at least about 2.2 mm, at least about 2.5 mm, at least about 2.8 mm, at least about 3 mm, at least about 3.2 mm, at least about 3.5 mm, at least about 3.8 mm, at least about 4 mm, at least about 4.2 mm, at least about 4.5 mm, at least about 4.8 mm, or at least about 5 mm.

In at least one embodiment, the thickness A of wheel 10 (e.g., a “thin” wheel or hand-held wheel) can be less than about 10 mm, such as not greater than about 9.0 mm such as, for example, not greater than about 8 mm, not greater than about 7 mm, not greater than about 6 mm, not greater than about 5.8 mm, not greater than about 5.5 mm, not greater than about 5.2 mm, not greater than about 5 mm, not greater than about 4.8 mm, not greater than about 4.5 mm, not greater than about 4.2 mm, not greater than about 4 mm, not greater than about 3.8 mm, not greater than about 3.5 mm, not greater than about 3.2 mm, not greater than about 3 mm, not greater than about 2.8 mm, not greater than about 2.5 mm, not greater than about 2.2 mm, not greater than about 2 mm. Wheel 10 can include a thickness “A” within a range between any of these minimum and maximum values.

Various embodiments of the thin wheel abrasive article may utilize a patterned working surface, wherein the working surface is a surface of the abrasive article intended to contact the workpiece and conduct the material removal operation. Shown in FIG. 1B, for instance, is a front view of a wheel 150, having mounting hole 155, center region 151, and working surface 153, which can be patterned to have an array of protrusions 157 that are separated by recesses (or channels) 159. It will be appreciated that any arrangement, distribution, or pattern may be utilized with any of the embodiments herein.

In an alternative embodiment, the thin wheel abrasive article can have a working surface that is essentially free of patterned features. FIG. 1C, for instance, shows a front view of wheel 100, having center region 101, a mounting hole 105, and working surface 103, which is substantially smooth (i.e., not patterned). In other words, the working surface 103 does not have protrusions or channels (recesses).

Further, the thin-wheel abrasive articles of the embodiments herein can have a body including an outer diameter 111 in a range of 50 mm to 400 mm, such as an outer diameter 111 in a range of between about 50 mm and 230 mm, such as 75 mm to 230 mm, or even a range of 75 mm to 150 mm.

Aspect ratios between wheel diameter and wheel thickness (diameter:thickness) can be at least about 15:1, at least about 20:1, at least about 25:1, at least about 35:1, at least about 50:1, at least about 75:1, at least about 100:1, or at least about 125:1. In other instances, the body of the thin wheel abrasive article can have an aspect ratio of diameter:thickness of not greater than about 125:1, not greater than about 100:1, not greater than about 75:1, not greater than about 50:1, not greater than about 35:1, not greater than about 25:1, not greater than about 20:1, or not greater than about 15:1. The ratio can be within a range between any of the above minimum and maximum values, such as within a range of about 125:1 to about 15:1, e.g., between about 100:1 to about 30:1. However, the invention can be practiced with wheels having different dimensions and different ratios between dimensions. For example, the thin-wheel abrasive article also can have a desirable aspect ratio in a range of 5 to 160, such as a range of 15 to 160, a range of 15 to 150, or even a range of 20 to 125.

The thin wheel abrasive articles of the embodiments herein can be rigid or flexible. For example, some thin wheel abrasive articles may have a reduced stiffness, and thus are referred to as pliable or compliant. Compliance of the wheel can be described by its ability to deflect, and wheels are capable of limited deflection without breaking. As an illustration, shown in FIG. 1D is a pliable thin wheel abrasive article 100 being rotated, as indicated by the arrow, against surface 122 of workpiece 120. As outer portion 103 of wheel 100 contacts and grinds the workpiece, it can be deflected out of plane with the rest of the body of the wheel, thus enhancing contact with the workpiece being processed.

The thin wheel abrasive articles of the embodiments herein can have certain constructions. It will be appreciated that the thin wheel abrasive articles of the embodiments herein may be monolithic articles formed of a single layer having a single construction, having a substantially uniform grade and structure throughout the volume of the body of the abrasive article. Alternatively, the thin wheel abrasive articles of the embodiments herein can be composite bodies having one or more layers, wherein at least two of the layers are different from each other based on a characteristic such as, content of abrasive particles, porosity type (e.g., closed or open), content of porosity, type of bond material, content of bond material, distribution of abrasive particles, hardness, flexibility, filler content, filler materials, shape of the layer, size (e.g., thickness, width, diameter, circumference, or length) of the layer, construction of the layer (e.g., solid, woven, non-woven, etc.) and a combination thereof.

According to one embodiment, a thin wheel abrasive article can be reinforced with one or more, (e.g., two or three) reinforcements, which may be in the form of layers, partial layers, discrete bundles of material distributed throughout the bond material, and a combination thereof. As used herein, terms such as “reinforced” or “reinforcement” refer to a discrete component that can be made of a material that is different from the bond material and blend of abrasive particles utilized to make the abrasive wheel. Typically, the reinforcement material does not include abrasive particles. With respect to the thickness of the wheel, a reinforcement can be embedded within the wheel body and such wheels typically are referred to as “internally” reinforced. A reinforcement also can be close to, or attached to the front and/or back face of the wheel. Several reinforcements can be disposed at various depths through the wheel thickness.

Certain reinforcements may have a circular geometry. The outer periphery of the reinforcement also can have a square, hexagon or another polygonal geometry. An irregular outer edge also can be used. Suitable non-circular reinforcement shapes that can be utilized are described in U.S. Pat. Nos. 6,749,496 and 6,942,561, incorporated herein by reference in their entirety. In many cases, a reinforcement extends from the inner diameter (edge of the central opening) to the outermost edge of the wheel. Partial reinforcements also can be employed and in such cases, the reinforcement may extend, for example, from the inner wheel diameter (outer diameter of the central opening) to about 30%, 60%, 70%, 75%, 80%, 85%, 90% 95%, 99% along the wheel radius or, for non-circular shapes, along the equivalent of the largest “radius” of the reinforcement.

Various reinforcement materials can be used to reinforce the wheel and more than one type of reinforcement material can be employed in a single wheel. Suitable reinforcements can be woven or non-woven, utilizing materials such as glass (C, E, or S2), Kevlar, Basalt, carbon, fabric organic materials (e.g., elastomers, rubbers), combinations of materials and so forth. For example, a reinforcement layer can be made of any number of various materials. An exemplary reinforcement layer may include a polymeric film (including primed films), such as a polyolefin film (e.g., polypropylene including biaxially oriented polypropylene), a polyester film (e.g., polyethylene terephthalate), or a polyamide film; a cellulose ester film; a metal foil; a mesh; a foam (e.g., natural sponge material or polyurethane foam); a cloth (e.g., cloth made from fibers or yams comprising fiberglass, polyester, nylon, silk, cotton, poly-cotton or rayon); a paper; a vulcanized paper; a vulcanized rubber; a vulcanized fiber; a nonwoven material; or any combination thereof, or treated embodiments thereof. A cloth backing can be woven or stitch bonded. In particular examples, the reinforcement layer is selected from a group consisting of paper, polymer film, cloth, cotton, poly-cotton, rayon, polyester, poly-nylon, vulcanized rubber, vulcanized fiber, fiberglass fabric, metal foil or any combination thereof. In other examples, the reinforcement layer may include a woven fiberglass fabric. In a particular example, the abrasive article may include one more layers of fiberglass between which a blend abrasive grains or particles are bound in a bond material such as a polymer matrix. Using reinforcements also can allow for shear at the interface between the reinforcement and adjacent region(s) of the wheel (which contain abrasive grains or particles distributed in a three dimensional bond material matrix).

In specific examples, the wheel has at least one or more fiberglass reinforcements, provided, for instance, in the form of fiberglass web(s). Typically, fiberglass webs are woven from very fine fibers of glass. Fiberglass web can be leno or plain woven. The fiberglass utilized can be E-glass (alumino-borosilicate glass with less than 1 wt % alkali oxides). Other types of fiberglass include, for example, A-glass (alkali-lime glass with little or no boron oxide), E-CR-glass (alumino-lime silicate with less than 1 wt % alkali oxides, with high acid resistance), C-glass (alkali-lime glass with high boron oxide content, used for example for glass staple fibers), D-glass (borosilicate glass with high dielectric constant), R-glass (alumino silicate glass without MgO and CaO with high mechanical requirements), and S-glass (alumino silicate glass without CaO but with high MgO content with high tensile strength).

Fiberglass webs can be arranged in a bonded abrasive tool such as a thin wheel tool in any suitable manner. In certain implementations, placement of a glass fiber web at the working face of the wheel may be avoided. Any of the embodiments herein can be reinforced with at least one fiberglass web having the similar inner diameter (corresponding to the diameter of the mounting hole) and the same outer diameter as the wheel. Partial web reinforcements that extend from the mounting hole through some but not all of the flat region of the wheel also can be used, as can be other web reinforcement placements.

Reinforcements can be characterized by one or more of the following physical parameters: weight (g/m²), thickness (mm), openings per cm and tensile strength (MPa), which can be further delineated with respect to the tensile strength of the warp (the long web components that run continuously for the length of the roll) and the tensile strength of the fill (the short components that run crosswise to the roll direction). In certain instances, one or more of the fiberglass webs employed has a minimum tensile strength of at least 200 MPa. Other factors include filament diameter, amount of coating, for instance, the coverage of the web with coating and others, as known in the art.

Chemical parameters can relate to the chemistry of the coating provided on the fiberglass web. Generally, there are two types of chemical “coatings.” A first coating, often referred to as “sizing,” is applied to the glass fiber strands immediately after they exit the bushing and may include ingredients such as film formers, lubricants, silanes, typically dispersed in water. The sizing typically provides protection of the filaments from processing-related degradation (such as abrasion). It can also provide abrasion protection during secondary processing such as weaving into a web. Strategic manipulation of properties associated with the first coating (sizing) can affect the compatibility of the glass fibers with the second coating, which, in turn, can affect compatibility of the coating with the resin bond. Typically, the second coating can be applied to the glass web and traditionally may include wax, used primarily to prevent “blocking” of the webs during shipping and storage. In many cases, the second coating can be compatible with both the sizing (first coating) and the matrix resin for which the reinforcement is intended.

Bonded abrasive tools such as thin wheel tools with or without reinforcement can be prepared by combining one or more types of abrasive grains or particles, a bond material, e.g., an organic material (resin) or an inorganic material, and in many cases other ingredients, such as, for instance, fillers, processing aids, lubricants, crosslinking agents, antistatic agents and so forth.

The various ingredients can be added in any suitable order and blended using known techniques and equipment such as, for instance, Eirich mixers, e.g., Model RV02, Littleford, bowl-type mixers and others. The resulting mixture can be used to form a green body. As used herein, the term “green” refers to a body which maintains its shape during the next process step, but generally does not have enough strength to maintain its shape permanently. For example, a resin bond present in the green body is in an uncured or unpolymerized state. The green body preferably is molded in the shape of the desired article, e.g., a thin wheel (cold, warm or hot molding).

One or more reinforcements can be incorporated in the green body. For example, a first portion of a mixture containing one or more types of abrasive grains or particles and a bond material can be placed and distributed at the bottom of an appropriate mold cavity and then covered with a first reinforcement. A suitable reinforcement is a fiberglass mesh or web such as described herein. A second portion of the bond/abrasive mixture can then be disposed and distributed over the first reinforcement layer. Additional reinforcement and/or bond/abrasive mixture layers can be provided, if so desired. The amounts of mix added to form a particular layer thickness can be calculated as known in the art. Other suitable sequences and/or techniques can be employed to shape the reinforced green body. For instance, a piece of paper or a fiberglass mesh or web or a piece of paper with a fiber glass mesh or web may be inserted in the mold cavity before the first mixture.

In some arrangements the various layers containing one or more types of abrasive grains or particles and bond material (also referred herein as “abrasive layers”) can differ from one another with respect to one or more characteristics such as, for instance, layer thickness, layer formulation (e.g., amounts and or types of ingredients being employed, grit size, grit shape, porosity) and the like.

To form such an abrasive article, such as a thin wheel, a first abrasive layer, a₁ (containing abrasive particles and bond material), is laid at the bottom of the mold. A first reinforcement V₁ is disposed on the first abrasive layer a1, followed by a second abrasive layer, a₂, which can be the same or different from the first abrasive layer, a₁. A second reinforcement, V₂ (which can be the same or different from V₁), can be disposed over the second abrasive layer, a₂. If desired, a third abrasive layer, a3, which may include abrasive particles and bond material can be used to cover the second reinforcement, V₂. The third abrasive layer can be the same or different with respect to one or more of the abrasive layers a₁ and/or a₂. Additional reinforcements and abrasive layers can be added, essentially as described, to obtain the desired number of abrasive layers and reinforcements. In another approach, a first reinforcement V₁ is placed at the very bottom of the mold and covered by a first abrasive layer a₁, with additional abrasive layers and reinforcements being disposed as described above. Arrangements in which adjacent abrasive layers aₓ and a_{y} are not separated by reinforcement also are possible, as are those in which two or more reinforcement layers, e.g., Vₓ and V_{y}, are not separated by an abrasive layer.

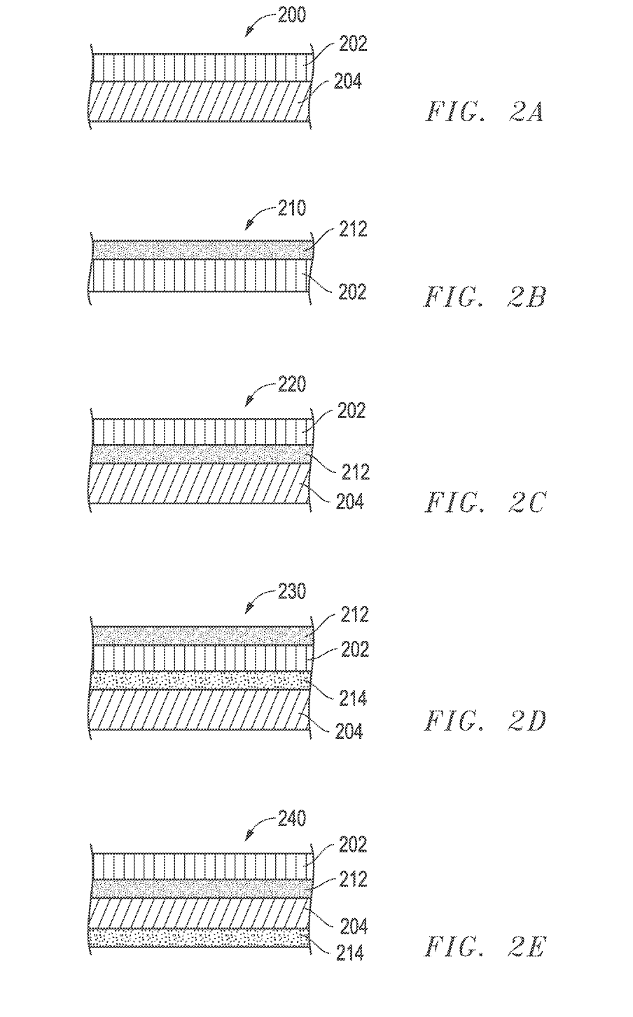

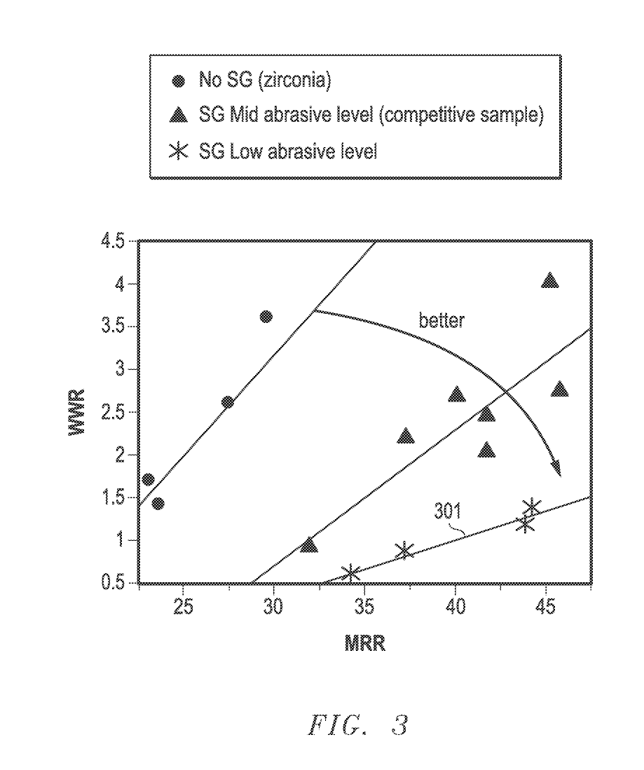

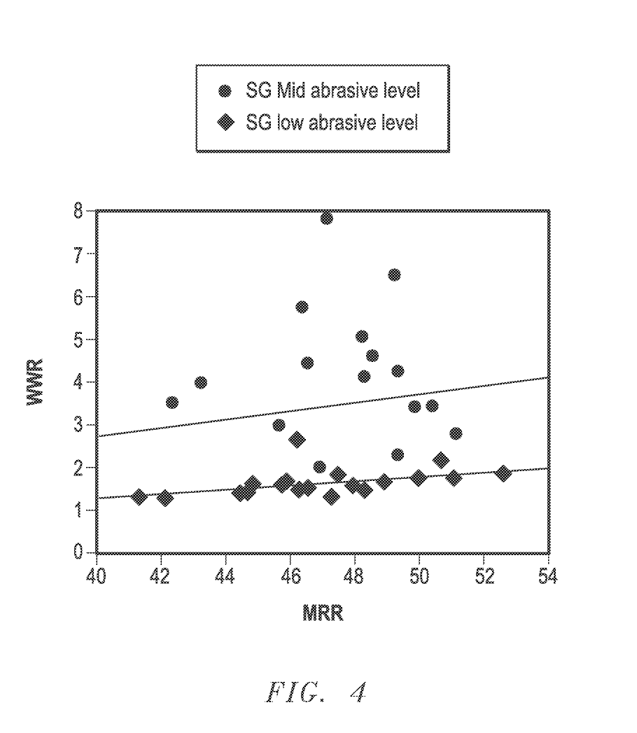

To illustrate, FIG. 2A is a cross-section of a portion of flat outer region 200 of a depressed center wheel having abrasive layers 202 and 204 and no reinforcement between them. The individual thicknesses of abrasive layers 202 and 204 can be substantially the same or can be different. For example, the difference in thickness between the abrasive layers can be at least about 5% different, at least about 10% different, at least about 20% different, at least about 25% different, at least about 30% different, or even at least about 50% different. FIG. 2B is a cross section of flat outer region 210 that may include one layer of reinforcements 212 and one abrasive layer 202. FIG. 2C is a cross section of flat outer region 220, which may include middle reinforcement 212 sandwiched between abrasive layers 202 and 204. FIG. 2D is a cross section of a portion of flat outer region 230 of a depressed center wheel having an alternating arrangement that may include reinforcement 212, abrasive layer 202, reinforcement 214 (which can be the same or different from reinforcement 212) and abrasive layer 204. FIG. 2E is a cross section of a portion of flat outer region 240 having an alternating arrangement which may include abrasive layer 202, reinforcement 212, abrasive layer 204 and reinforcement 214 at the working surface of the wheel. In many cases, the thickness of the reinforcement is less than that of any of the abrasive layers.

The individual thicknesses of the abrasive layers can be substantially the same. In certain instances, the thicknesses of the abrasive layers can be different, even significantly different. For example, the difference in thickness between two abrasive layers can be at least about 5% different, at least about 10% different, at least about 20% different, at least about 25% different, at least about 30% different, or even at least about 50% different. Engineered differences in the thicknesses between two abrasive layers can promote certain mechanical properties and advantages in grinding performance. In addition or alternatively to thickness variations, abrasive layers and/or reinforcements may differ with respect to formulation, materials employed and/or other properties.

Particular Aspects of Different Abrasive Layers

As noted above with respect to FIGS. 2A-2E, the thin wheel abrasive article can include various constructions including one or more different reinforcement layers, and various arrangements of the reinforcement layers with respect to the order and arrangement of the abrasive layers. As also noted generally herein, the thin wheel abrasive articles of the embodiments herein can include different abrasive layers with respect to each other. In one particular embodiment, the thin wheel abrasive article can include a fine back layer that is configured to provide support to the abrasive article and a grinding layer, which can define a working surface of the thin wheel abrasive article configured to conduct a majority of the material removal operations as compared to the fine back layer. Abrasive articles according to embodiments herein, which may include a fine back layer and a grinding layer, with or without interspersed reinforcements, can be both suitable to produce on a commercial scale and equal to or better in performance than a comparative abrasive article that may include one or more grinding layers without a fine back layer.

According to particular embodiments, the grinding layer may have a particular volumetric ratio GLV_{b}/GLVₐₚ, where GLV_{b} is a volume percent of bond for a total volume of the grinding layer and GLVₐₚ is a volume percent of abrasive particles for a total volume of the grinding layer. For example, the grinding layer may have a volumetric ratio GLV_{b}/GLVₐₚ of at least about 0.4, such as, at least about 0.45, at least about 0.5, at least about 0.55, at least about 0.6, at least about 0.65, at least about 0.7, at least about 0.75, at least about 0.8, at least about 0.85, at least about 0.9, at least about 0.95, at least about 1, at least about 1.05, at least about 1.1, at least about 1.15, at least about 1.2, at least about 1.25, at least about 1.3, at least about 1.4 or even at least about 1.5. According to still other embodiments, the grinding layer may have a volumetric ratio GLV_{b}/GLVₐₚ of not greater than about 2.0, such as, not greater than about 1.5, not greater than about 1.45, not greater than about 1.4, not greater than about 1.35, not greater than about 1.3, not greater than about 1.25, not greater than about 1.2, not greater than about 1.15, not greater than about 1.1, not greater than about 1.05, not greater than about 1, not greater than about 0.95, not greater than about 0.9, not greater than about 0.85, not greater than about 0.8, not greater than about 0.75, not greater than about 0.7, not greater than about 0.65 or even not greater than about 0.6. It will be appreciated that the grinding layer may have a volumetric ratio GLV_{b}/GLVₐₚ of any numerical value within any of the minimum and maximum values noted above. It will be further appreciated that the grinding layer may have a volumetric ratio GLV_{b}/GLVₐₚ within a range between any of the minimum and maximum values noted above.

According to yet another particular embodiment, the abrasive particles in the grinding layer may have a particular average particle size. For example, the abrasive particles in the grinding layer may have an average particle size of at least about 650 microns, such as, at least about 700 microns, at least about 750 microns, at least about 800 microns, at least about 850 microns, at least about 900 microns, at least about 950 microns, at least about 1000 microns, at least about 1050 microns, at least about 1100 microns or even at least about 1150 microns. According to still another embodiment, the abrasive particles in the grinding layer may have an average particle size of not greater than about 1200 microns, such as, not greater than about 1150 microns, not greater than about 1100 microns, not greater than about 1050 microns, not greater than about 1000 microns, not greater than about 950 microns, not greater than about 900 microns, not greater than about 850 microns, not greater than about 800 microns, not greater than about 750 microns, not greater than about 700 microns or even not greater than about 650 microns. It will be appreciated that the abrasive particle in the grinding layer may have an average particle size of any numerical value within any of the minimum and maximum values noted above. It will be further appreciated that the abrasive particles in the grinding layer may have an average particle size within a range between any of the minimum and maximum values noted above.

According to still another embodiment, the grinding layer may include a particular content of bond for a total volume of the grinding layer. For example, the grinding layer may include at least about 24 vol % bond for a total volume of the grinding layer, such as, at least about 28 vol %, at least about 30 vol %, at least about 33 vol %, at least about 35 vol %, at least about 38 vol %, at least about 40 vol %, at least about 43 vol %, at least about 45 vol % or even at least about 48 vol %. According to still another embodiment, the grinding layer may include not greater than about 50 vol % bond for a total volume of the grinding layer, such as, not greater than about 48 vol %, not greater than about 45 vol %, not greater than about 43 vol %, not greater than about 40 vol %, not greater than about 38 vol % or even not greater than about 35 vol %. It will be appreciated that the content of bond in the grinding layer may be any numerical value within any of the minimum and maximum values noted above. It will be further appreciated that the content of bond in the grinding layer may be within a range between any of the minimum and maximum values noted above.

According to still another embodiment, the bond in the grinding layer may include a particular content of resin for a total volume of the bond in the grinding layer. For example, the bond in the grinding layer may include at least about 50 vol % resin for a total volume of the bond in the grinding layer, such as, at least about 55 vol % resin, at least about 60 vol % resin, at least about 65 vol % resin, at least about 70 vol % resin or even at least about 75 vol % resin. According to still other embodiment, the bond in the grinding layer may include not greater than about 80 vol % resin for a total volume of the bond in the grinding layer, not greater than about 75 vol % resin, not greater than about 70 vol % resin, not greater than about 65 vol % resin or even not greater than about 60 vol % resin. It will be appreciated that the content of resin in the bond in the grinding layer may be any numerical value within any of the minimum and maximum values noted above. It will be further appreciated that the content of resin in the bond in the grinding layer may be within a range between any of the minimum and maximum values noted above.

According to yet another embodiment, the grinding layer may include a particular content of abrasive particles for a total volume of the grinding layer. For example, the grinding layer may include at least about 35 vol % abrasive particles for a total volume of the grinding layer, such as, at least about 38 vol %, at least about 40 vol %, at least about 43 vol %, at least about 45 vol %, at least about 48 vol %, at least about 50 vol %, at least about 53 vol %, at least about 55 vol % or even at least about 58 vol %. According to yet another embodiment, the grinding layer may include not greater than about 60 vol % abrasive particles for a total volume of the grinding layer, such as, not greater than about 58 vol %, not greater than about 45 vol %, not greater than about 43 vol %, not greater than about 40 vol %, not greater than about 38 vol % or even not greater than about 35 vol %. It will be appreciated that the content of abrasive particles in the grinding layer may be any numerical value within any of the minimum and maximum values noted above. It will be further appreciated that the content of abrasive particles in the grinding layer may be within a range between any of the minimum and maximum values noted above.

According to still another embodiment, the grinding layer may include a particular porosity for a total volume of the grinding layer. For example, the grinding layer may include at least about 10 vol % porosity for a total volume of the grinding layer, such as, at least about 12 vol %, at least about 15 vol %, at least about 18 vol %, at least about 20 vol %, at least about 22 vol %, at least about 25 vol %, at least about 28 vol %, at least about 30 vol % or even at least about 33 vol %. According to still another embodiment, the grinding layer may include not greater than about 35 vol % porosity for a total volume of the grinding layer, not greater than about 32 vol %, not greater than about 30 vol %, not greater than about 28 vol %, not greater than about 25 vol %, not greater than about 23 vol % or even not greater than about 20 vol %. It will be appreciated that the porosity in the grinding layer may be any numerical value within any of the minimum and maximum values noted above. It will be further appreciated that the porosity in the grinding layer may be within a range between any of the minimum and maximum values noted above.

According to still other embodiment, the grinding layer may include one or more fillers. In particular instances, the content and type of fillers between two or more abrasive layers may be different with respect to each other. Certain suitable fillers can include active and/or inactive fillers in the form of a finely divided powder, granules, spheres, fibers or some otherwise shaped materials. Mixtures of more than one filler are also possible. Note that fillers may be functional (e.g., grinding aids such as lubricant, porosity inducers, and/or secondary abrasive grain) or more inclined toward non-functional qualities such as aesthetics (e.g., coloring agent). In a specific implementation, the filler may include potassium fluoroborate and/or manganese compounds, e.g., chloride salts of manganese, for instance an eutectic salt made by fusing manganese dichloride (MnCl₂) and potassium chloride (KCl), available from Washington Mills under the designation of MKCS.

A non-exhaustive list of active fillers can include Cryolite, potassium aluminum fluoride (PAF), KBF₄, K₂SO₄, barium sulfate, sulfides (FeS₂, ZnS), NaCl/KCl, low melting metal oxides, or combinations thereof. Any or all of these additional ingredients can be combined with the blend of abrasive particles, the bond material or with a mixture of the blend of abrasive particles and bond material. An active filler material, such as PAF, which is a mixture of K₃AlF₆ and KAlF₄, can be added to the bond material in order to corrode certain workpieces, such as metals and reduce the friction between the wheel and workpiece.

A non-exhaustive list of inactive fillers can include CaO, CaCO₃, Ca(OH)₂, CaSiO₃, Kyanite (a mixture of Al₂O₃—SiO₂), Saran (Polyvinylidene chloride), Nephenline (Na, K), wood powder, coconut shell flour, stone dust, feldspar, kaolin, quartz, other forms of silica, short glass fibers, asbestos fibers, surface-treated fine grain (silicon carbide, corundum etc.), pumice stone, cork powder and combinations thereof.

The grinding layer can include any combination of active fillers and inactive fillers. It will be appreciated that the grinding layer may incorporate only one type of filler (i.e., an active filler or inactive filler). In particular instances, the content of active filler within an abrasive layer can be greater than a content of the inactive filler within the same abrasive layer. For other embodiments, the content of inactive filler in an abrasive layer can be greater than a content of active filler within the same abrasive layer.

According to another embodiment, the grinding layer may include a particular content of a filler for a total volume of the grinding layer. For example, the grinding layer may include at least about 0.5 vol % of a filler for a total volume of the grinding layer, such as, at least about 1 vol %, at least about 3 vol %, at least about 5 vol %, at least about 10 vol %, at least about 15 vol % or even at least about 20 vol %. According to yet another embodiment, the grinding layer may include not greater than about 30 vol % of a filler for a total volume of the grinding layer, such as, not greater than about 20 vol %, not greater than about 15 vol %, not greater than about 10 vol %, not greater than about 5 vol %, not greater than about 3 vol % or even not greater than about 1 vol %. It will be appreciated that the content of a filler in the grinding layer may be any numerical value within any of the minimum and maximum values noted above. It will be further appreciated that the content of bond in the grinding layer may be within a range between any of the minimum and maximum values noted above.

According to still another embodiment, the grinding layer may include a particular content of an active filler for a total volume of the grinding layer. For example, the grinding layer may include at least about 0.5 vol % of an active filler for a total volume of the grinding layer, such as, at least about 1 vol %, at least about 3 vol %, at least about 5 vol %, at least about 10 vol %, at least about 15 vol % or even at least about 20 vol %. According to still another embodiment, the grinding layer may include not greater than about 30 vol % of an active filler for a total volume of the grinding layer, such as, not greater than about 20 vol %, not greater than about 15 vol %, not greater than about 10 vol %, not greater than about 5 vol %, not greater than about 3 vol % or even not greater than about 1 vol %. It will be appreciated that the content of an active filler in the grinding layer may be any numerical value within any of the minimum and maximum values noted above. It will be further appreciated that the content of an active filler in the grinding layer may be within a range between any of the minimum and maximum values noted above.

According to still another embodiment, the grinding layer may include a particular content of potassium fluoroborate for a total volume of the grinding layer. For example, the grinding layer may include at least about 0.5 vol % potassium fluoroborate for a total volume of the grinding layer, such as, at least about 1 vol %, at least about 3 vol %, at least about 5 vol % or even at least about 10 vol %. According to still another embodiment, the grinding layer may include not greater than about 20 vol % potassium fluoroborate for a total volume of the grinding layer, such as, not greater than about 15 vol %, not greater than about 10 vol %, not greater than about 8 vol %, not greater than about 5 vol %, not greater than about 3 vol % or even not greater than about 1 vol %. It will be appreciated that the content of potassium fluoroborate in the grinding layer may be any numerical value within any of the minimum and maximum values noted above. It will be further appreciated that the content of potassium fluoroborate in the grinding layer may be within a range between any of the minimum and maximum values noted above.

According to yet another embodiment, the grinding layer may include a particular content of a magnesium compound for a total volume of the grinding layer. For example, the grinding layer may include at least about 0.5 vol % of a manganese compound for a total volume of the grinding layer, such as, at least about 1 vol %, at least about 3 vol %, at least about 5 vol % or even at least about 10 vol %. According to still other embodiments, the grinding layer may include not greater than about 20 vol % of a manganese compound for a total volume of the grinding layer, or even, not greater than about 15 vol %, not greater than about 10 vol %, not greater than about 8 vol %, not greater than about 5 vol %, not greater than about 3 vol % or even not greater than about 1 vol %. It will be appreciated that the content of a manganese compound in the grinding layer may be any numerical value within any of the minimum and maximum values noted above. It will be further appreciated that the content of a manganese compound in the grinding layer may be within a range between any of the minimum and maximum values noted above.

According to still another embodiment, the grinding layer may include a particular content of pyrite for a total volume of the grinding layer. For example, the grinding layer may include at least about 0.5 vol % pyrite for a total volume of the grinding layer, such as, at least about 1 vol %, at least about 3 vol %, at least about 5 vol % or even at least about 10 vol %. According to still another embodiment, the grinding layer may include not greater than about 20 vol % pyrite for a total volume of the grinding layer, such as, not greater than about 15 vol %, not greater than about 10 vol %, not greater than about 8 vol %, not greater than about 5 vol %, not greater than about 3 vol % or even not greater than about 1 vol %. It will be appreciated that the content of pyrite in the grinding layer may be any numerical value within any of the minimum and maximum values noted above. It will be further appreciated that the content of pyrite in the grinding layer may be within a range between any of the minimum and maximum values noted above.

According to yet another embodiment, the grinding layer may include a particular content of PAF for a total volume of the grinding layer. For example, the grinding layer may include at least about 0.5 vol % PAF for a total volume of the grinding layer, at least about 1 vol %, at least about 3 vol %, at least about 5 vol % or even at least about 10 vol %. According to still another embodiment, the grinding layer may include not greater than about 20 vol % PAF for a total volume of the grinding layer, such as, not greater than about 15 vol %, not greater than about 10 vol %, not greater than about 8 vol %, not greater than about 5 vol %, not greater than about 3 vol % or even not greater than about 1 vol %. It will be appreciated that the content of PAF in the grinding layer may be any numerical value within any of the minimum and maximum values noted above. It will be further appreciated that the content of PAF in the grinding layer may be within a range between any of the minimum and maximum values noted above.

According to particular embodiments, the fine back layer may have a particular volumetric ratio FBV_{b}/FBVₐₚ, where FBV_{b} is a volume percent of bond for a total volume of the fine back layer and FBVₐₚ is a volume percent of abrasive particles for a total volume of the fine back layer. For example, the fine back layer may have a volumetric ratio FBV_{b}/FBVₐₚ of at least about 0.4, such as, at least about 0.45, at least about 0.5, at least about 0.55, at least about 0.6, at least about 0.65, at least about 0.7, at least about 0.75, at least about 0.8, at least about 0.85, at least about 0.9, at least about 0.95, at least about 1, at least about 1.05, at least about 1.1, at least about 1.15, at least about 1.2, at least about 1.25, at least about 1.3, at least about 1.4 or even at least about 1.5. According to still other embodiments, the fine back layer may have a volumetric ratio FBV_{b}/FBVₐₚ of not greater than about 2.0, such as, not greater than about 1.5, not greater than about 1.45, not greater than about 1.4, not greater than about 1.35, not greater than about 1.3, not greater than about 1.25, not greater than about 1.2, not greater than about 1.15, not greater than about 1.1, not greater than about 1.05, not greater than about 1, not greater than about 0.95, not greater than about 0.9, not greater than about 0.85, not greater than about 0.8, not greater than about 0.75, not greater than about 0.7, not greater than about 0.65 or even not greater than about 0.6. It will be appreciated that the fine back layer may have a volumetric ratio FBV_{b}/FBVₐₚ of any numerical value within any of the minimum and maximum values noted above. It will be further appreciated that the fine back layer may have a volumetric ratio FBV_{b}/FBVₐₚ within a range between any of the minimum and maximum values noted above.

According to yet another particular embodiment, the abrasive particles in the fine back layer may have a particular average particle size. For example, the abrasive particles in the fine back layer may have an average particle size of at least about 200 microns, such as, at least about 250 microns, at least about 300 microns, at least about 400 microns, at least about 450 microns, at least about 500 microns, at least about 550 microns, at least about 600 microns, at least about 700 microns, at least about 800 microns or even at least about 900 microns. According to still another embodiment, the abrasive particles in the fine back layer may have an average particle size of not greater than about 1200 microns, not greater than about 1100 microns, not greater than about 1000 microns, not greater than about 900 microns, not greater than about 800 microns, not greater than about 700 microns, not greater than about 600 microns, not greater than about 550 microns, not greater than about 500 microns, not greater than about 450 microns, not greater than about 400 microns or even not greater than about 350 microns. It will be appreciated that the abrasive particle in the fine back layer may have an average particle size of any numerical value within any of the minimum and maximum values noted above. It will be further appreciated that the abrasive particles in the fine back layer may have an average particle size within a range between any of the minimum and maximum values noted above.

According to still another embodiment, the fine back layer may include a particular content of bond for a total volume of the fine back layer. For example, the fine back layer may include at least about 20 vol % bond for a total volume of the fine back layer, such as, at least about 23 vol %, at least about 25 vol %, at least about 28 vol %, at least about 30 vol %, at least about 35 vol %, at least about 40 vol % or even at least about 45 vol %. According to still another embodiment, the fine back layer may include not greater than about 50 vol % bond for a total volume of the fine back layer, such as, not greater than about 45 vol %, not greater than about 40 vol %, not greater than about 35 vol %, not greater than about 30 vol %, not greater than about 25 vol % or even not greater than about 20 vol %. It will be appreciated that the content of bond in the fine back layer may be any numerical value within any of the minimum and maximum values noted above. It will be further appreciated that the content of bond in the fine back layer may be within a range between any of the minimum and maximum values noted above.

According to still another embodiment, the bond in the fine back layer may include a particular content of resin for a total volume of the bond in the fine back layer. For example, the bond in the fine back layer may include at least about 50 vol % resin for a total volume of the bond in the fine back layer, such as, at least about 55 vol % resin, at least about 60 vol % resin, at least about 65 vol % resin, at least about 70 vol % resin or even at least about 75 vol % resin. According to still other embodiment, the bond in the fine back layer may include not greater than about 80 vol % resin for a total volume of the bond in the fine back layer, not greater than about 75 vol % resin, not greater than about 70 vol % resin, not greater than about 65 vol % resin or even not greater than about 60 vol % resin. It will be appreciated that the content of resin in the bond in the fine back layer may be any numerical value within any of the minimum and maximum values noted above. It will be further appreciated that the content of resin in the bond in the fine back layer may be within a range between any of the minimum and maximum values noted above.

According to yet another embodiment, the fine back layer may include a particular content of abrasive particles for a total volume of the fine back layer. For example, the fine back layer may include at least about 20 vol % abrasive particles for a total volume of the fine back layer, such as, at least about 38 vol %, at least about 40 vol %, at least about 43 vol %, at least about 45 vol %, at least about 48 vol %, at least about 50 vol %, at least about 53 vol %, at least about 55 vol % or even at least about 58 vol %. According to yet another embodiment, the fine back layer may include not greater than about 60 vol % abrasive particles for a total volume of the fine back layer, such as, not greater than about 55 vol %, not greater than about 50 vol %, not greater than about 45 vol %, not greater than about 40 vol %, not greater than about 35 vol % or even not greater than about 30 vol %. It will be appreciated that the content of abrasive particles in the fine back layer may be any numerical value within any of the minimum and maximum values noted above. It will be further appreciated that the content of abrasive particles in the fine back layer may be within a range between any of the minimum and maximum values noted above.

According to still another embodiment, the fine back layer may include a particular porosity for a total volume of the fine back layer. For example, the fine back layer may include at least about 10 vol % porosity for a total volume of the fine back layer, such as, at least about 12 vol %, at least about 15 vol %, at least about 18 vol %, at least about 20 vol %, at least about 22 vol %, at least about 25 vol %, at least about 28 vol %, at least about 30 vol % or even at least about 33 vol %. According to still another embodiment, the fine back layer may include not greater than about 35 vol % porosity for a total volume of the fine back layer, not greater than about 32 vol %, not greater than about 30 vol %, not greater than about 28 vol %, not greater than about 25 vol %, not greater than about 23 vol % or even not greater than about 20 vol %. It will be appreciated that the porosity in the fine back layer may be any numerical value within any of the minimum and maximum values noted above. It will be further appreciated that the porosity in the fine back layer may be within a range between any of the minimum and maximum values noted above.

According to still other embodiment, the fine back layer may include one or more fillers. In particular instances, the content and type of fillers between two or more abrasive layers may be different with respect to each other. Certain suitable fillers can include active and/or inactive fillers in the form of a finely divided powder, granules, spheres, fibers or some otherwise shaped materials. Mixtures of more than one filler are also possible. Note that fillers may be functional (e.g., grinding aids such as lubricant, porosity inducers, and/or secondary abrasive grain) or more inclined toward non-functional qualities such as aesthetics (e.g., coloring agent). In a specific implementation, the filler may include potassium fluoroborate and/or manganese compounds, e.g., chloride salts of manganese, for instance an eutectic salt made by fusing manganese dichloride (MnCl₂) and potassium chloride (KCl), available from Washington Mills under the designation of MKCS.

A non-exhaustive list of active fillers can include Cryolite, potassium aluminum fluoride (PAF), KBF₄, K₂SO₄, barium sulfate, sulfides (FeS₂, ZnS), NaCl/KCl, low melting metal oxides, or combinations thereof. Any or all of these additional ingredients can be combined with the blend of abrasive particles, the bond material or with a mixture of the blend of abrasive particles and bond material. An active filler material, such as PAF, which is a mixture of K₃AlF₆ and KAlF₄, can be added to the bond material in order to corrode certain workpieces, such as metals and reduce the friction between the wheel and workpiece.

A non-exhaustive list of inactive fillers can include CaO, CaCO₃, Ca(OH)₂, CaSiO₃, Kyanite (a mixture of Al₂O₃—SiO₂), Saran (Polyvinylidene chloride), Nephenline (Na, K), wood powder, coconut shell flour, stone dust, feldspar, kaolin, quartz, other forms of silica, short glass fibers, asbestos fibers, surface-treated fine grain (silicon carbide, corundum etc.), pumice stone, cork powder and combinations thereof.

The fine back layer can include any combination of active fillers and inactive fillers. It will be appreciated that the fine back layer may incorporate only one type of filler (i.e., an active filler or inactive filler). In particular instances, the content of active filler within an abrasive layer can be greater than a content of the inactive filler within the same abrasive layer. For other embodiments, the content of inactive filler in an abrasive layer can be greater than a content of active filler within the same abrasive layer.

According to another embodiment, the fine back layer may include a particular content of a filler for a total volume of the fine back layer. For example, the fine back layer may include at least about 0.5 vol % of a filler for a total volume of the fine back layer, such as, at least about 1 vol %, at least about 3 vol %, at least about 5 vol %, at least about 10 vol %, at least about 15 vol % or even at least about 20 vol %. According to yet another embodiment, the fine back layer may include not greater than about 30 vol % of a filler for a total volume of the fine back layer, such as, not greater than about 20 vol %, not greater than about 15 vol %, not greater than about 10 vol %, not greater than about 5 vol %, not greater than about 3 vol % or even not greater than about 1 vol %. It will be appreciated that the content of a filler in the fine back layer may be any numerical value within any of the minimum and maximum values noted above. It will be further appreciated that the content of bond in the fine back layer may be within a range between any of the minimum and maximum values noted above.

According to still another embodiment, the fine back layer may include a particular content of an active filler for a total volume of the fine back layer. For example, the fine back layer may include at least about 0.5 vol % of an active filler for a total volume of the fine back layer, such as, at least about 1 vol %, at least about 3 vol %, at least about 5 vol %, at least about 10 vol %, at least about 15 vol % or even at least about 20 vol %. According to still another embodiment, the fine back layer may include not greater than about 30 vol % of an active filler for a total volume of the fine back layer, such as, not greater than about 20 vol %, not greater than about 15 vol %, not greater than about 10 vol %, not greater than about 5 vol %, not greater than about 3 vol % or even not greater than about 1 vol %. It will be appreciated that the content of an active filler in the fine back layer may be any numerical value within any of the minimum and maximum values noted above. It will be further appreciated that the content of an active filler in the fine back layer may be within a range between any of the minimum and maximum values noted above.

According to still another embodiment, the fine back layer may include a particular content of potassium fluoroborate for a total volume of the fine back layer. For example, the fine back layer may include at least about 0.5 vol % potassium fluoroborate for a total volume of the fine back layer, such as, at least about 1 vol %, at least about 3 vol %, at least about 5 vol % or even at least about 10 vol %. According to still another embodiment, the fine back layer may include not greater than about 20 vol % potassium fluoroborate for a total volume of the fine back layer, such as, not greater than about 15 vol %, not greater than about 10 vol %, not greater than about 8 vol %, not greater than about 5 vol %, not greater than about 3 vol % or even not greater than about 1 vol %. It will be appreciated that the content of potassium fluoroborate in the fine back layer may be any numerical value within any of the minimum and maximum values noted above. It will be further appreciated that the content of potassium fluoroborate in the fine back layer may be within a range between any of the minimum and maximum values noted above.

According to yet another embodiment, the fine back layer may include a particular content of a magnesium compound for a total volume of the fine back layer. For example, the fine back layer may include at least about 0.5 vol % of a manganese compound for a total volume of the fine back layer, such as, at least about 1 vol %, at least about 3 vol %, at least about 5 vol % or even at least about 10 vol %. According to still other embodiments, the fine back layer may include not greater than about 20 vol % of a manganese compound for a total volume of the fine back layer, or even, not greater than about 15 vol %, not greater than about 10 vol %, not greater than about 8 vol %, not greater than about 5 vol %, not greater than about 3 vol % or even not greater than about 1 vol %. It will be appreciated that the content of a manganese compound in the fine back layer may be any numerical value within any of the minimum and maximum values noted above. It will be further appreciated that the content of a manganese compound in the fine back layer may be within a range between any of the minimum and maximum values noted above.

According to still another embodiment, the fine back layer may include a particular content of pyrite for a total volume of the fine back layer. For example, the fine back layer may include at least about 0.5 vol % pyrite for a total volume of the fine back layer, such as, at least about 1 vol %, at least about 3 vol %, at least about 5 vol % or even at least about 10 vol %. According to still another embodiment, the fine back layer may include not greater than about 20 vol % pyrite for a total volume of the fine back layer, such as, not greater than about 15 vol %, not greater than about 10 vol %, not greater than about 8 vol %, not greater than about 5 vol %, not greater than about 3 vol % or even not greater than about 1 vol %. It will be appreciated that the content of pyrite in the fine back layer may be any numerical value within any of the minimum and maximum values noted above. It will be further appreciated that the content of pyrite in the fine back layer may be within a range between any of the minimum and maximum values noted above.

According to yet another embodiment, the fine back layer may include a particular content of PAF for a total volume of the fine back layer. For example, the fine back layer may include at least about 0.5 vol % PAF for a total volume of the fine back layer, at least about 1 vol %, at least about 3 vol %, at least about 5 vol % or even at least about 10 vol %. According to still another embodiment, the fine back layer may include not greater than about 20 vol % PAF for a total volume of the fine back layer, such as, not greater than about 15 vol %, not greater than about 10 vol %, not greater than about 8 vol %, not greater than about 5 vol %, not greater than about 3 vol % or even not greater than about 1 vol %. It will be appreciated that the content of PAF in the fine back layer may be any numerical value within any of the minimum and maximum values noted above. It will be further appreciated that the content of PAF in the fine back layer may be within a range between any of the minimum and maximum values noted above.

The fine back layer may include abrasive particles that are different than one or more abrasive particle types of the grinding layer based on at least one abrasive characteristic selected from the group of average grain size, composition, content of alumina, content of silica, content of oxide-based compounds, hardness, friability, shape, density, content of binder (e.g., in the case of an agglomerated particle), and a combination thereof.

The fine back layer and grinding layer may be further differentiated from each other on the basis of grade and/or structure of the abrasive material. For example, one or more of the content of abrasive particles, bond material, and/or porosity may be different between the fine back layer and grinding layer. The difference in any one of the content of abrasive particles, bond material, and porosity can be at least about 2%, such as at least about 3%, at least about 5%, at least about 8%, at least about 10%, at least about 12%, at least about 15%, or even at least about 18%. In certain instances, the fine back layer can have a greater content of bond material and a lesser content of abrasive particles as compared to the grinding layer.

According to particular embodiments, the abrasive article may have a particular volumetric ratio AAV_{b}/AAVₐₚ, where AAV_{b} is a volume percent of bond for a total volume of the abrasive article and AAVₐₚ is a volume percent of abrasive particles for a total volume of the abrasive article. For example, the abrasive article may have a volumetric ratio AAV_{b}/AAVₐₚ of at least about 0.4, such as, at least about 0.45, at least about 0.5, at least about 0.55, at least about 0.6, at least about 0.65, at least about 0.7, at least about 0.75, at least about 0.8, at least about 0.85, at least about 0.9, at least about 0.95, at least about 1, at least about 1.05, at least about 1.1, at least about 1.15, at least about 1.2, at least about 1.25, at least about 1.3, at least about 1.4 or even at least about 1.5. According to still other embodiments, the abrasive article may have a volumetric ratio AAV_{b}/AAVₐₚ of not greater than about 2.0, such as, not greater than about 1.5, not greater than about 1.45, not greater than about 1.4, not greater than about 1.35, not greater than about 1.3, not greater than about 1.25, not greater than about 1.2, not greater than about 1.15, not greater than about 1.1, not greater than about 1.05, not greater than about 1, not greater than about 0.95, not greater than about 0.9, not greater than about 0.85, not greater than about 0.8, not greater than about 0.75, not greater than about 0.7, not greater than about 0.65 or even not greater than about 0.6. It will be appreciated that the abrasive article may have a volumetric ratio AAV_{b}/AAVₐₚ of any numerical value within any of the minimum and maximum values noted above. It will be further appreciated that the abrasive article may have a volumetric ratio AAV_{b}/AAVₐₚ within a range between any of the minimum and maximum values noted above.

According to yet another particular embodiment, the abrasive particles in the abrasive article may have a particular average particle size. For example, the abrasive particles in the abrasive article may have an average particle size of at least about 200 microns, such as, at least about 250 microns, at least about 300 microns, at least about 400 microns, at least about 450 microns, at least about 500 microns, at least about 550 microns, at least about 600 microns, at least about 700 microns, at least about 800 microns or even at least about 900 microns. According to still another embodiment, the abrasive particles in the abrasive article may have an average particle size of not greater than about 1200 microns, not greater than about 1100 microns, not greater than about 1000 microns, not greater than about 900 microns, not greater than about 800 microns, not greater than about 700 microns, not greater than about 600 microns, not greater than about 550 microns, not greater than about 500 microns, not greater than about 450 microns, not greater than about 400 microns or even not greater than about 350 microns. It will be appreciated that the abrasive particle in the abrasive article may have an average particle size of any numerical value within any of the minimum and maximum values noted above. It will be further appreciated that the abrasive particles in the abrasive article may have an average particle size within a range between any of the minimum and maximum values noted above.

According to still another embodiment, the abrasive article may include a particular content of bond for a total volume of the abrasive article. For example, the abrasive article may include at least about 20 vol % bond for a total volume of the abrasive article, such as, at least about 23 vol %, at least about 25 vol %, at least about 28 vol %, at least about 30 vol %, at least about 35 vol %, at least about 40 vol % or even at least about 45 vol %. According to still another embodiment, the abrasive article may include not greater than about 50 vol % bond for a total volume of the abrasive article, such as, not greater than about 45 vol %, not greater than about 40 vol %, not greater than about 35 vol %, not greater than about 30 vol %, not greater than about 25 vol % or even not greater than about 20 vol %. It will be appreciated that the content of bond in the abrasive article may be any numerical value within any of the minimum and maximum values noted above. It will be further appreciated that the content of bond in the abrasive article may be within a range between any of the minimum and maximum values noted above.

According to still another embodiment, the bond in the abrasive article may include a particular content of resin for a total volume of the bond in the fine back layer. For example, the bond in the abrasive article may include at least about 50 vol % resin for a total volume of the bond in the abrasive article, such as, at least about 55 vol % resin, at least about 60 vol % resin, at least about 65 vol % resin, at least about 70 vol % resin or even at least about 75 vol % resin. According to still other embodiment, the bond in the abrasive article may include not greater than about 80 vol % resin for a total volume of the bond in the abrasive article, not greater than about 75 vol % resin, not greater than about 70 vol % resin, not greater than about 65 vol % resin or even not greater than about 60 vol % resin. It will be appreciated that the content of resin in the bond in the abrasive article may be any numerical value within any of the minimum and maximum values noted above. It will be further appreciated that the content of resin in the bond in the fine back layer may be within a range between any of the minimum and maximum values noted above.

According to yet another embodiment, the abrasive article may include a particular content of abrasive particles for a total volume of the abrasive article. For example, the abrasive article may include at least about 20 vol % abrasive particles for a total volume of the abrasive article, such as, at least about 38 vol %, at least about 40 vol %, at least about 43 vol %, at least about 45 vol %, at least about 48 vol %, at least about 50 vol %, at least about 53 vol %, at least about 55 vol % or even at least about 58 vol %. According to yet another embodiment, the abrasive article may include not greater than about 60 vol % abrasive particles for a total volume of the abrasive article, such as, not greater than about 55 vol %, not greater than about 50 vol %, not greater than about 45 vol %, not greater than about 40 vol %, not greater than about 35 vol % or even not greater than about 30 vol %. It will be appreciated that the content of abrasive particles in the abrasive article may be any numerical value within any of the minimum and maximum values noted above. It will be further appreciated that the content of abrasive particles in the abrasive article may be within a range between any of the minimum and maximum values noted above.

According to still another embodiment, the abrasive article may include a particular porosity for a total volume of the abrasive article. For example, the abrasive article may include at least about 10 vol % porosity for a total volume of the abrasive article, such as, at least about 12 vol %, at least about 15 vol %, at least about 18 vol %, at least about 20 vol %, at least about 22 vol %, at least about 25 vol %, at least about 28 vol %, at least about 30 vol % or even at least about 33 vol %. According to still another embodiment, the abrasive article may include not greater than about 35 vol % porosity for a total volume of the abrasive article, not greater than about 32 vol %, not greater than about 30 vol %, not greater than about 28 vol %, not greater than about 25 vol %, not greater than about 23 vol % or even not greater than about 20 vol %. It will be appreciated that the porosity in the abrasive article may be any numerical value within any of the minimum and maximum values noted above. It will be further appreciated that the porosity in the abrasive article may be within a range between any of the minimum and maximum values noted above.

According to still other embodiment, the abrasive article may include one or more fillers. In particular instances, the content and type of fillers between two or more abrasive layers may be different with respect to each other. Certain suitable fillers can include active and/or inactive fillers in the form of a finely divided powder, granules, spheres, fibers or some otherwise shaped materials. Mixtures of more than one filler are also possible. Note that fillers may be functional (e.g., grinding aids such as lubricant, porosity inducers, and/or secondary abrasive grain) or more inclined toward non-functional qualities such as aesthetics (e.g., coloring agent). In a specific implementation, the filler may include potassium fluoroborate and/or manganese compounds, e.g., chloride salts of manganese, for instance, an eutectic salt made by fusing manganese dichloride (MnCl₂) and potassium chloride (KCl), available from Washington Mills under the designation of MKCS.

A non-exhaustive list of active fillers can include Cryolite, potassium aluminum fluoride (PAF), KBF₄, K₂SO₄, barium sulfate, sulfides (FeS₂, ZnS), NaCl/KCl, low melting metal oxides, or combinations thereof. Any or all of these additional ingredients can be combined with the blend of abrasive particles, the bond material or with a mixture of the blend of abrasive particles and bond material. An active filler material, such as PAF, which is a mixture of K₃AlF₆ and KAlF₄, can be added to the bond material in order to corrode certain workpieces, such as metals and reduce the friction between the wheel and workpiece.

A non-exhaustive list of inactive fillers can include CaO, CaCO₃, Ca(OH)₂, CaSiO₃, Kyanite (a mixture of Al₂O₃—SiO₂), Saran (Polyvinylidene chloride), Nephenline (Na, K), wood powder, coconut shell flour, stone dust, feldspar, kaolin, quartz, other forms of silica, short glass fibers, asbestos fibers, surface-treated fine grain (silicon carbide, corundum etc.), pumice stone, cork powder and combinations thereof.

The abrasive article can include any combination of active fillers and inactive fillers. It will be appreciated that the abrasive article may incorporate only one type of filler (i.e., an active filler or inactive filler). In particular instances, the content of active filler within an abrasive layer can be greater than a content of the inactive filler within the same abrasive layer. For other embodiments, the content of inactive filler in an abrasive layer can be greater than a content of active filler within the same abrasive layer.

According to another embodiment, the abrasive article may include a particular content of a filler for a total volume of the abrasive article. For example, the abrasive article may include at least about 0.5 vol % of a filler for a total volume of the abrasive article, such as, at least about 1 vol %, at least about 3 vol %, at least about 5 vol %, at least about 10 vol %, at least about 15 vol % or even at least about 20 vol %. According to yet another embodiment, the abrasive article may include not greater than about 30 vol % of a filler for a total volume of the abrasive article, such as, not greater than about 20 vol %, not greater than about 15 vol %, not greater than about 10 vol %, not greater than about 5 vol %, not greater than about 3 vol % or even not greater than about 1 vol %. It will be appreciated that the content of a filler in the abrasive article may be any numerical value within any of the minimum and maximum values noted above. It will be further appreciated that the content of bond in the abrasive article may be within a range between any of the minimum and maximum values noted above.

According to still another embodiment, the abrasive article may include a particular content of an active filler for a total volume of the abrasive article. For example, the abrasive article may include at least about 0.5 vol % of an active filler for a total volume of the abrasive article, such as, at least about 1 vol %, at least about 3 vol %, at least about 5 vol %, at least about 10 vol %, at least about 15 vol % or even at least about 20 vol %. According to still another embodiment, the abrasive article may include not greater than about 30 vol % of an active filler for a total volume of the abrasive article, such as, not greater than about 20 vol %, not greater than about 15 vol %, not greater than about 10 vol %, not greater than about 5 vol %, not greater than about 3 vol % or even not greater than about 1 vol %. It will be appreciated that the content of an active filler in the abrasive article may be any numerical value within any of the minimum and maximum values noted above. It will be further appreciated that the content of an active filler in the abrasive article may be within a range between any of the minimum and maximum values noted above.

According to still another embodiment, the abrasive article may include a particular content of potassium fluoroborate for a total volume of the abrasive article. For example, the abrasive article may include at least about 0.5 vol % potassium fluoroborate for a total volume of the abrasive article, such as, at least about 1 vol %, at least about 3 vol %, at least about 5 vol % or even at least about 10 vol %. According to still another embodiment, the abrasive article may include not greater than about 20 vol % potassium fluoroborate for a total volume of the abrasive article, such as, not greater than about 15 vol %, not greater than about 10 vol %, not greater than about 8 vol %, not greater than about 5 vol %, not greater than about 3 vol % or even not greater than about 1 vol %. It will be appreciated that the content of potassium fluoroborate in the abrasive article may be any numerical value within any of the minimum and maximum values noted above. It will be further appreciated that the content of potassium fluoroborate in the abrasive article may be within a range between any of the minimum and maximum values noted above.

According to yet another embodiment, the abrasive article may include a particular content of a magnesium compound for a total volume of the abrasive article. For example, the abrasive article may include at least about 0.5 vol % of a manganese compound for a total volume of the abrasive article, such as, at least about 1 vol %, at least about 3 vol %, at least about 5 vol % or even at least about 10 vol %. According to still other embodiments, the abrasive article may include not greater than about 20 vol % of a manganese compound for a total volume of the abrasive article, or even, not greater than about 15 vol %, not greater than about 10 vol %, not greater than about 8 vol %, not greater than about 5 vol %, not greater than about 3 vol % or even not greater than about 1 vol %. It will be appreciated that the content of a manganese compound in the abrasive article may be any numerical value within any of the minimum and maximum values noted above. It will be further appreciated that the content of a manganese compound in the abrasive article may be within a range between any of the minimum and maximum values noted above.

According to still another embodiment, the abrasive article may include a particular content of pyrite for a total volume of the abrasive article. For example, the abrasive article may include at least about 0.5 vol % pyrite for a total volume of the abrasive article, such as, at least about 1 vol %, at least about 3 vol %, at least about 5 vol % or even at least about 10 vol %. According to still another embodiment, the abrasive article may include not greater than about 20 vol % pyrite for a total volume of the abrasive article, such as, not greater than about 15 vol %, not greater than about 10 vol %, not greater than about 8 vol %, not greater than about 5 vol %, not greater than about 3 vol % or even not greater than about 1 vol %. It will be appreciated that the content of pyrite in the abrasive article may be any numerical value within any of the minimum and maximum values noted above. It will be further appreciated that the content of pyrite in the abrasive article may be within a range between any of the minimum and maximum values noted above.

According to yet another embodiment, the abrasive article may include a particular content of PAF for a total volume of the abrasive article. For example, the abrasive article may include at least about 0.5 vol % PAF for a total volume of the abrasive article, at least about 1 vol %, at least about 3 vol %, at least about 5 vol % or even at least about 10 vol %. According to still another embodiment, the abrasive article may include not greater than about 20 vol % PAF for a total volume of the abrasive article, such as, not greater than about 15 vol %, not greater than about 10 vol %, not greater than about 8 vol %, not greater than about 5 vol %, not greater than about 3 vol % or even not greater than about 1 vol %. It will be appreciated that the content of PAF in the abrasive article may be any numerical value within any of the minimum and maximum values noted above. It will be further appreciated that the content of PAF in the abrasive article may be within a range between any of the minimum and maximum values noted above.

In a particular embodiment, the abrasive layer can include a plurality of fillers, wherein each of the fillers may be present in different contents relative to each other. For example, at least one abrasive layer of a thin wheel abrasive article according to an embodiment can include a first filler, which may be present in an amount of at least about 10 vol % for a total volume of the fillers within the abrasive layer. In certain instances, the content of the first filler may be greater, such as at least about 12 vol %, or even at least about 15 vol %. In another non-limiting embodiment, the content of the first filler can be not greater than about 20 vol % of the total volume of the fillers within the abrasive layer, such as not greater than about 15 vol %, or even not greater than about 13 vol %. The abrasive layer can have a first filler content within a range between any of the minimum and maximum percentages noted above.

The first filler of an embodiment can include an active filler or inactive filler. In some embodiments, the average particle size of the first filler can be not greater than about 35 microns. In some examples, the average particle size of the first filler can be not greater than about 30 microns, such as, not greater than about 20 microns, not greater than about 15 microns, not greater than about 10 microns, or even not greater than about 8 microns. In other non-limiting embodiments, the first filler can have an average particle size of at least about 0.1 microns, such as at least about 1 micron, at least about 2 microns, or even at least about 3 microns. The average particle size of the first filler can be within a range between any of the minimum and maximum values noted above.

In other embodiments, the abrasive layer may include a second filler. The second filler may include any of the filler materials noted herein. The second filler material can have a composition that is different than a composition of the first filler, and in particular, may have a completely distinct composition as compared to the first filler. In certain instances, the second filler material can include potassium. The second filler may further include aluminum, fluoride or a combination thereof. For example, the second filler may include a compound including potassium, aluminum, and fluoride. In one particular instance, the second filler may consist essentially of KAlF₄.

In some embodiments, the abrasive layer may include a greater content of the first filler (vol %) as compared to a content of the second filler (vol %). The abrasive layer may include a ratio (V1/V2) of at least about 1, wherein V1 represents a content of the first filler (vol %) within the abrasive layer and V2 represents a content of the second filler (vol %) within the abrasive layer. In other examples, the ratio (V1/V2) may be at least about 0.5, at least about 0.8, at least about 1, at least about 1.1, at least about 1.2. In other non-limiting embodiments, the ratio (V1/V2) may be not greater than about 2, such as not greater than about 1.5, not greater than about 1.4, or even not greater than about 1.3, or even not greater than about 1.2. The ratio (V1/V2) can be within a range between any of the minimum and maximum values noted above.

In a particular embodiment, the second filler can be at least about 10 vol % of a total volume of the fillers. For example, the second filler can be at least about 15 vol % of the total volume of the fillers, such as at least about 20 vol %, or even at least about 24 vol %. In certain non-limiting examples, the second filler can be not greater than about 30 vol % of the total volume of the fillers, such as not greater than about 20 vol %, or even not greater than about 16 vol %. The second filler content can be within a range between any of the minimum and maximum values noted above.

In some instances, the second filler may include an average particle size of not greater than about 70 microns. For example, the average particle size of the second filler can be not greater than about 65 microns, such as not greater than about 55 microns, or even not greater than about 45 microns. In other non-limiting embodiments, the average particle size of the second filler can be at least about 0.1 microns, at least about 1 micron, at least about 5 microns, such as at least about 15 microns, or even at least about 25 microns. The second filler average particle size can be within a range between any of the minimum and maximum values noted above.

In other embodiments, any one of the abrasive layers of the thin wheel abrasive article may include a third filler. The third filler may include any of the filler materials noted herein. The third filler material can have a composition that is different than a composition of the first filler and the second filler, and in particular, may have a completely distinct composition as compared to the first filler and the second filler. According to one embodiment, the third filler may include calcium. The third filler may further include oxygen, or a compound including calcium and oxygen. For example, in one particular embodiment, the third filler may include CaO, and more particularly, can consist essentially of CaO.

The third filler may include an average particle size of not greater than about 70 microns. In particular instances, the third filler average particle size can be not greater than about 65 microns, such as not greater than about 55 microns. Non-limiting embodiments may include a third filler having an average particle size of at least about 0.5 microns, such as at least about 1 micron, at least about 5 microns, at least about 10 microns, at least about 15 microns, such as at least about 25 microns, or even at least about 35 microns. The third filler average particle size can be within a range between any of the minimum and maximum values noted above.

The abrasive layer also may include a greater content of the first filler (vol %) as compared to the content of the third filler (vol %). The abrasive layer may include a ratio (V1/V3) of at least about 10, wherein V1 represents a content of the first filler (vol %) within the abrasive layer, and V3 represents a content of the third filler (vol %) within the abrasive layer. In other examples the ratio (V1/V3) may be at least about 25, such as at least about 40, at least about 50, at least about 75, or even at least about 100. In other non-limiting embodiments, the ratio (V1/V3) can be not greater than about 200, such as not greater than about 175, not greater than about 150, not greater than about 120, or even not greater than about 100, not greater than about 90, or even not greater than about 80. The ratio (V1/V3) can be within a range between any of the minimum and maximum values noted above.

Still other embodiments of the abrasive layer may include a greater content of a second filler (vol %) as compared to a content of the third filler (vol %). The abrasive layer may include a ratio (V2/V3) of at least about 50, wherein V2 represents a content of the second filler (vol %) within the abrasive layer and V3 represents a content of the third filler (vol %) within the abrasive layer. In some examples, the ratio (V2/V3) can be at least about 70, at least about 80, at least about 90, at least about 100, or even at least about 110. Non-limiting examples may include the ratio (V2/V3) can be not greater than about 150, such as not greater than about 125, not greater than about 115, not greater than about 100, or even not greater than about 75. The ratio (V2/V3) can be within a range between any of the minimum and maximum values noted above.

In a particular embodiment, the third filler can be at least about 0.01 vol % of a total volume of the fillers. In certain instances, the third filler can be greater, such as at least about 0.05 vol %, or even at least about 0.1 vol %. In another non-limiting embodiment, the third filler can be not greater than about 10 vol % of the total volume of the fillers, such as not greater than about 5 vol %, not greater than about 2 vol %, or even not greater than about 1 vol %. The fillers can have a third filler content within a range between any of the minimum and maximum values noted above.

In other embodiments, the abrasive layer may include a combination of the first filler, a second filler, and a third filler. For example, the abrasive layer may include a total content of the first filler, second filler and third filler of at least about 15 vol % for a total volume of the abrasive layer. Alternatively, the total content of the first filler, second filler, third filler, and fourth filler may be at least about 18 vol % of the total volume of the abrasive layer, such as at least about 20 vol %, at least about 22 vol %, or even at least about 24 vol %. Non-limiting embodiments may include the total content of the first filler, second filler, third filler, and fourth filler being not greater than about 40 vol % of the total volume of the abrasive layer, such as not greater than about 25 vol %, or even not greater than about 16 vol %. The filler content of the abrasive layer can be within a range between any of the minimum and maximum values noted above.

Any of the foregoing volume percentages and ratios based on volume percent are applicable for weight percent and ratio of weight percent as well. Weight percent can be based on the total weight of the grinding layer, the fine back layer or the abrasive article.

Techniques that can be used to produce the bonded abrasive article, e.g., a thin wheel with or without reinforcement, include, for example, cold pressing, warm pressing or hot pressing. Cold pressing, for instance, is described in U.S. Pat. No. 3,619,151, which is incorporated herein by reference. During cold pressing, the materials in the mold are maintained at ambient temperature, e.g., normally less than about 30° centigrade (C). Pressure is applied to the uncured mass of material by suitable means, such as a hydraulic press. The pressure applied can be, e.g., in the range of about 70.3 kg/cm2 (0.5 tsi) to about 2109.3 kg/cm2 (15 tsi), and more typically in the range of about 140.6 kg/cm2 (1 tsi) to about 843.6 kg/cm2 (6 tsi). The holding time within the press can be, for example, within the range of from about 2.5 seconds to about 1 minute.

Warm pressing is a technique very similar to cold pressing, except that the temperature of the mixture in the mold is elevated, usually to a temperature below about 120° C., and more often, below about 100° C. Suitable pressure and holding time parameters can be, for example, the same as in the case of cold pressing.

Hot pressing is described, for example, in a Bakelite publication, Rutaphen™—Resins for Grinding Wheels—Technical Information. (KN 50E-09.92-G&S-BA), and in Another Bakelite publication: Rutaphen Phenolic Resins—Guide/Product Ranges/Application (KN107/e-10.89 GS-B G). Useful information can also be found in Thermosetting Plastics, edited by J. F. Monk, Chapter 3 (“Compression Moulding of Thermosets”), 1981 George Goodwin Ltd. in association with The Plastics and Rubber Institute. For the purpose of this disclosure, the scope of the term “hot pressing” may include hot coining procedures, which are known in the art. In a typical hot coining procedure, pressure is applied to the mold assembly after it is taken out of the heating furnace.

To illustrate, an abrasive article can be prepared by disposing layers of a mixture including one or more types of abrasive grains or particles, bond material and, optionally, other ingredients, below and/or above one or more reinforcement layer(s) in an appropriate mold, usually made of stainless-, high carbon-, or high chrome-steel. Shaped plungers may be employed to cap off the mixture. Cold preliminary pressing is sometimes used, followed by preheating after the loaded mold assembly has been placed in an appropriate furnace. The mold assembly can be heated by any convenient method: electricity, steam, pressurized hot water, hot oil or gas flame. A resistance- or induction-type heater can be employed.

The specific temperature, pressure and time ranges can vary and will depend on the specific materials employed, the type of equipment in use, dimensions and other parameters. Pressures can be, for example, in the range of from about 70.3 kg/cm² (0.5 tsi) to about 703.2 kg/cm² (5.0 tsi), and more typically, from about 70.3 kg/cm² (0.5 tsi) to about 281.2 kg/cm² (2.0 tsi). The pressing temperature for this process is typically in the range of about 115° C. to about 200° C.; and more typically, from about 140° C. to about 190° C. The holding time within the mold is usually about 30 to about 60 seconds per millimeter of abrasive article thickness.

In the embodiments employing an organic bond material, the bonded abrasive article can be formed by curing the organic bond material. As used herein, the term “final cure temperature” is the temperature at which the molded article is held to effect polymerization, e.g., cross-linking, of the organic bond material, thereby forming the abrasive article. As used herein, “cross-linking” refers to the chemical reaction(s) that take(s) place in the presence of heat and often in the presence of a cross-linking agent, e.g., “hexa” or hexamethylenetetramine, whereby the organic bond composition hardens. Generally, the molded article is soaked at a final cure temperature for a period of time, e.g., between 6 hours and 48 hours, e.g., between 10 and 36 hours, or until the center of mass of the molded article reaches the cross-linking temperature and desired grinding performance (e.g., density of the cross-link) In an embodiment, the molded article can be soaked for between 20 and 30 hours.

According to certain embodiments, the curing temperature can be in the range of from about 150° C. to about 250° C. In more specific embodiments employing organic bonds, the curing temperature can be in the range of about 150° C. to about 230° C. Polymerization of phenol based resins, for example, generally takes place at a temperature in the range of between about 110° C. and about 225° C. Resole resins generally polymerize at a temperature in a range of between about 140° C. and about 225° C. and novolac resins generally at a temperature in a range of between about 110° C. and about 195° C.

The Abrasive Particles

Bonded abrasive tools such as thin wheels with or without reinforcement, including depressed center wheels, can be prepared by combining one or more types of abrasive particles or grains, a bond material (e.g., an organic material (resin) or an inorganic material), and in many cases other ingredients, such as, for instance, active or inactive fillers, processing aids, lubricants, crosslinking agents, antistatic agents and so forth.

In an embodiment, the abrasive article may include a thin wheel tool having a body including one or more types of abrasive particles (e.g., such as a blend) contained in a bond material. The blend of abrasive particles can include a first type of abrasive particle, such as a shaped or unshaped abrasive particle, and a second type of abrasive particle different from the first type of abrasive particle. Either or both of the first and second types of abrasive particles can include a seeded sol-gel ceramic.

Abrasive particles can include inorganic materials, organic materials, naturally sourced materials (e.g., minerals), superabrasive materials, synthesized materials (e.g., polycrystalline diamond compacts) and a combination thereof. Some suitable exemplary abrasive particles can include oxides, carbides, nitrides, borides, oxycarbides, oxynitrides, oxyborides, and a combination thereof. More particularly, the abrasive particles can include silica, alumina (fused or sintered), zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery, or any combination thereof. In an example, the abrasive grains include at least one type of primary abrasive grain selected from the group of abrasive families consisting of seeded or unseeded sol gel alumina or Al2O3-ZrC2. A non-exhaustive list of abrasive grains from the seeded or unseeded sol gel alumina family that can be used may include SG grain or NQ grain, commercially available from Saint-Gobain Abrasives, Inc. of Worcester, Mass., 3M321 Cubitron grain or 3M324 Cubitron grain commercially available from 3M Corporation of St. Paul, Minn., or combinations thereof. A non-exhaustive list of abrasive grains from the AC-ZrC family that can be used may include NZ Plus grain, commercially available from Saint-Gobain Abrasives, Inc. of Worcester, Mass., ZF grain or ZS grain, commercially available from Saint-Gobain Abrasives, Inc. of Worcester, Mass., ZK40 grain or ZZK40 grain, commercially available from Treibacher Industry, Inc. of Toronto, Ontario CA, or ZR25B grain or ZR25R grain, commercially available from Alcan, Inc. of Montreal, Quebec CA. In another example, the amount of the primary abrasive grain may include between about 0 percent to about 100 percent of the total amount of abrasive grain by volume.

Embodiments of the abrasive particles may include a particular content of seeded sol-gel ceramic particles for a total number of abrasive particles in the abrasive article. For example, the abrasive particles may include at least about 10% seeded sol-gel ceramic particles for a total number of abrasive particles, such as, at least about 20%, at least about 30%, at least about 40%, at least about 50%, at least about 60%, at least about 70%, at least about 80%, at least about 90% or even at least about 95%. According to still other embodiments, the abrasive particles may include not greater than about 99% seeded sol-gel ceramic particles for a total number of abrasive particles, such as, not greater than about 90%, not greater than about 80%, not greater than about 70%, not greater than about 60%, not greater than about 50%, not greater than about 40%, not greater than about 30%, not greater than about 20% or even not greater than about 15%. Other embodiments may consist essentially of seeded sol-gel ceramic particles, or some embodiments may be 100% seeded sol-gel ceramic particles. It will be appreciated that the content of seeded sol-gel ceramic particles for a total number of the abrasive particles may be any numerical value within any of the minimum and maximum values noted above. It will be further appreciated that the content of seeded sol-gel ceramic particles for a total number of the abrasive particles may be within a range between any of the minimum and maximum values noted above.

Embodiments of the abrasive particles may include a particular content of seeded sol-gel ceramic in volume percent for a total volume of the abrasive particles. For example, the abrasive particles may include at least about 10 vol % seeded sol-gel ceramic for a total volume of abrasive particles, such as, at least about 20 vol % seeded sol-gel ceramic, at least about 30 vol % seeded sol-gel ceramic, at least about 40 vol % seeded sol-gel ceramic, at least about 50 vol % seeded sol-gel ceramic, at least about 60 vol % seeded sol-gel ceramic, at least about 70 vol % seeded sol-gel ceramic, at least about 80 vol % seeded sol-gel ceramic, at least about 90 vol % seeded sol-gel ceramic or even at least about 95 vol % seeded sol-gel ceramic. According to still other embodiments, the abrasive particles may include not greater than about 99 vol % seeded sol-gel ceramic for a total volume of abrasive particles, such as, not greater than about 90 vol % seeded sol-gel ceramic, not greater than about 80 vol % seeded sol-gel ceramic, not greater than about 70 vol % seeded sol-gel ceramic, not greater than about 60 vol % seeded sol-gel ceramic, not greater than about 50 vol % seeded sol-gel ceramic, not greater than about 40 vol % seeded sol-gel ceramic, not greater than about 30 vol % seeded sol-gel ceramic, not greater than about 20 vol % seeded sol-gel ceramic or even not greater than about 15 vol % seeded sol-gel ceramic. Other embodiments may consist essentially of seeded sol-gel ceramic, or some embodiments may be 100 vol % seeded sol-gel ceramic. It will be appreciated that the content of seeded sol-gel ceramic in volume percent for a total volume of the abrasive particles may be any numerical value within any of the minimum and maximum values noted above. It will be further appreciated that the content of seeded sol-gel ceramic in volume percent for a total volume of the abrasive particles may be within a range between any of the minimum and maximum values noted above.

Embodiments of the abrasive particles may include a particular content of seeded sol-gel ceramic in weight percent for a total weight of the abrasive particles. For example, the abrasive particles may include at least about 10 wt % seeded sol-gel ceramic for a total weight of abrasive particles, such as, at least about 20 wt % seeded sol-gel ceramic, at least about 30 wt % seeded sol-gel ceramic, at least about 40 wt % seeded sol-gel ceramic, at least about 50 wt % seeded sol-gel ceramic, at least about 60 wt % seeded sol-gel ceramic, at least about 70 wt % seeded sol-gel ceramic, at least about 80 wt % seeded sol-gel ceramic, at least about 90 wt % seeded sol-gel ceramic or even at least about 95 wt % seeded sol-gel ceramic. According to still other embodiments, the abrasive particles may include not greater than about 99 wt % seeded sol-gel ceramic for a total weight of abrasive particles, such as, not greater than about 90 wt % seeded sol-gel ceramic, not greater than about 80 wt % seeded sol-gel ceramic, not greater than about 70 wt % seeded sol-gel ceramic, not greater than about 60 wt % seeded sol-gel ceramic, not greater than about 50 wt % seeded sol-gel ceramic, not greater than about 40 wt % seeded sol-gel ceramic, not greater than about 30 wt % seeded sol-gel ceramic, not greater than about 20 wt % seeded sol-gel ceramic or even not greater than about 15 wt % seeded sol-gel ceramic. Other embodiments may consist essentially of seeded sol-gel ceramic, or some embodiments may be 100 wt % seeded sol-gel ceramic. It will be appreciated that the content of seeded sol-gel ceramic in weight percent for a total weight of the abrasive particles may be any numerical value within any of the minimum and maximum values noted above. It will be further appreciated that the content of seeded sol-gel ceramic in weight percent for a total weight of the abrasive particles may be within a range between any of the minimum and maximum values noted above.

The abrasive particles may include at least one of shaped particles and crushed sharp particles. The abrasive particles can include unshaped particles and not shaped particles.

The abrasive particles can include a particular hardness. For example, the abrasive particles can have a Mohs hardness of at least about 6, such as at least about 7, at least about 8, or even at least about 9.

The blend can also include a first type of abrasive particles contained within a first abrasive layer (e.g., the grinding layer) and a second type of abrasive particles contained in a second abrasive layer (e.g., the fine back layer), where the second abrasive layer is distinct from the first abrasive layer. That is, the blend of abrasive particles do not necessarily need to be contained within the same layer, however, in certain embodiments, a single layer can include a combination of two or more different types of abrasive particles. In particular instances, a first type of abrasive particle may be contained within one or more grinding layer and the second type of abrasive particle may be contained within one or more fine back layers. As described herein, the bond material between the abrasive layers may be the same or different.

A type of abrasive particle can be defined by at least a composition, a mechanical property (e.g., hardness, friability, etc.), particle size, particle shape, and a combination thereof. In an embodiment, the first type of abrasive particle can be the same or different from the second type of abrasive particle by at least one particle characteristic selected from the group consisting of friability, hardness, toughness, density, porosity, composition, average particle size, average grain size, or a combination thereof.

In an embodiment, the abrasive particles can include a particular content of the first type of abrasive particles for a total content of the abrasive particles. For example, at least about 30 wt %, at least about 35 wt %, at least about 40 wt %, at least about 42 wt %, at least about 44 wt %, at least about 46 wt %, or at least about 48 wt % of the first type of abrasive particle, based on the total weight of the abrasive particles. In another embodiment, the abrasive particles can include not greater than about 60 wt %, not greater than about 55 wt %, not greater than about 50 wt %, not greater than about 48 wt %, not greater than about 45 wt %, not greater than about 42 wt % of the first type of abrasive particle, based on the total weight of the abrasive particles. The first type of abrasive particle can be present within a range between any of these minimum and maximum percentages. For example, the first type of abrasive particle can be present in a range between about 40 wt % and about 50 wt %, such as between about 42 wt % and about 48 wt %.

According to a particular embodiment, the abrasive particle can have a certain composition. In an embodiment, the first type of abrasive particle can include seeded gel particles, such as seeded sol-gel ceramic particles. The abrasive particles can be shaped particles and/or they can be unshaped (i.e., randomly shaped) particles, such as crushed particles. The crushed abrasive particles can be sharp particles and/or blocky particles.

The shaped abrasive particle also can include various shapes, structure, or configuration. For example, shaped abrasive particles can have a well-defined and regular arrangement (i.e., non-random) of edges and sides, thus defining an identifiable shape. For example, a shaped abrasive particle may have a polygonal shape as viewed in a plane defined by any two dimensions of length, width, and height (e.g., viewed in a plane defined by a length and a width). Some exemplary polygonal shapes can be triangular, quadrilateral (e.g., rectangular, square, trapezoidal, parallelogram), a pentagon, a hexagon, a heptagon, an octagon, a nonagon, a decagon, and the like. Additionally, the shaped abrasive particle can have a three-dimensional shape defined by a polyhedral shape, such as a prismatic shape or the like. Further, the shaped abrasive particles may have curved edges and/or surfaces, such that the shaped abrasive particles can have convex, concave, ellipsoidal shapes.

The shaped abrasive particles can be in the form of any alphanumeric character, e.g., 1, 2, 3, etc., A, B, C. etc. Further, the shaped abrasive particles can be in the form of a symbol, trademark, a character selected from the Greek alphabet, the modern Latin alphabet, the ancient Latin alphabet, the Russian alphabet, any other alphabet (e.g., Kanji characters), and any combination thereof.

According to certain embodiments, the shaped abrasive particles may be disposed in the grinding layer of the abrasive body. According to still other embodiments, the shaped abrasive particles may be disposed in a fine back layer of the abrasive body. According to still other embodiments, the shaped abrasive particles may be disposed in both the grinding layer and the fine back layer of the abrasive body.

The size of abrasive particles often are expressed as a grit size, and charts showing a relation between a grit size and its corresponding average particle size, expressed in microns or inches, are known in the art as are correlations to the corresponding United States Standard Sieve (USSS) mesh size. Particle size selection depends upon the application or process for which the abrasive tool is intended. Different sizes also can be used. For example, 16 grit abrasive particles may include abrasive particle having an abrasive particles size of at least about 750 microns and not greater than about 1650 microns with an average abrasive particle size of about 1100 microns, 20 grit abrasive particles may include abrasive particle having an abrasive particle size of at least about 650 and not greater than about to 1400 microns with an average abrasive particle size of about 950, 24 grit abrasive particles may include abrasive particles having an abrasive particle size of at least about 450 and not greater than about 1100 microns with an average abrasive particle size of about 700 and 46 grit abrasive particles may include abrasive particles having an abrasive particle size of at least about 200 to 600 microns with an average abrasive particle size of about 350.

The Bond Material

The abrasive article of the present invention, as well as the methods of making and using the abrasive article, can include various bond materials and precursor bond materials. In specific implementations of the present invention, at least one of the bond material and the precursor bond material is an organic material or bond, also referred to as a “polymeric” or “resin” bond, typically obtained by curing a bonding material. An example of an organic bond material that can be employed to fabricate bonded abrasive articles may include one or more phenolic resins. Such resins can be obtained by polymerizing phenols with aldehydes, in particular, formaldehyde, paraformaldehyde or furfural. In addition to phenols, cresols, xylenols and substituted phenols can be employed. Comparable formaldehyde-free resins also can be utilized. Examples of other suitable organic bond materials include epoxy resins, polyester resins, polyurethanes, polyester, rubber, polyimide, polybenzimidazole, aromatic polyamide, modified phenolic resins (such as: epoxy modified and rubber modified resins, or phenolic resin blended with plasticizers etc.), and so forth, as well as mixtures thereof. Specific, non-limiting examples of resins that can be used include the following: the resins sold by Dynea Oy, Finland, under the trade name Prefere and available under the catalog/product numbers 8522G, 8528G, 8680G, and 8723G; the resins sold by Hexion Specialty Chemicals, OH, under the trade name Rutaphen® and available under the catalog/product numbers 9507P, 8686SP, and SP223; and the resins sold by Sumitomo, formerly Durez Corporation, TX, under the following catalog/product numbers: 29344, 29346, and 29722. In an example, the bond material may include a dry resin material.

Among phenolic resins, resoles generally are obtained by a one step reaction between aqueous formaldehyde and phenol in the presence of an alkaline catalyst. Novolac resins, also known as two-stage phenolic resins generally are produced under acidic conditions and during milling process blended with a cross-linking agent, such as hexamethylenetetramine (often also referred to as “hexa”). An exemplary phenolic resin may include resole and novolac. Resole phenolic resins can be alkaline catalyzed and have a ratio of formaldehyde to phenol of greater than or equal to one, such as from 1:1 to 3:1. Novolac phenolic resins can be acid catalyzed and have a ratio of formaldehyde to phenol of less than one, such as 0.5:1 to 0.8:1.

The bond material can contain more than one phenolic resin, e.g., at least one resole and at least novolac-type phenolic resin. In many cases, at least one phenol-based resin is in liquid form. Suitable combinations of phenolic resins are described, for example, in U.S. Pat. No. 4,918,116 to Gardziella, et al., the entire contents of which are incorporated herein by reference.

An epoxy resin can include an aromatic epoxy or an aliphatic epoxy. Aromatic epoxies components include one or more epoxy groups and one or more aromatic rings. An example aromatic epoxy may include epoxy derived from a polyphenol, e.g., from bisphenols, such as bisphenol A (4,4′-isopropylidenediphenol), bisphenol F (bis[4-hydroxyphenyl]methane), bisphenol S (4,4′-sulfonyldiphenol), 4,4′-cyclohexylidenebisphenol, 4,4′-biphenol, 4,4′-(9-fluorenylidene)diphenol, or any combination thereof. The bisphenol can be alkoxylated (e.g., ethoxylated or propoxylated) or halogenated (e.g., brominated). Examples of bisphenol epoxies include bisphenol diglycidyl ethers, such as diglycidyl ether of Bisphenol A or Bisphenol F. A further example of an aromatic epoxy may include triphenylolmethane triglycidyl ether, 1,1,1-tris(p-hydroxyphenyl)ethane triglycidyl ether, or an aromatic epoxy derived from a monophenol, e.g., from resorcinol (for example, resorcin diglycidyl ether) or hydroquinone (for example, hydroquinone diglycidyl ether). Another example is nonylphenyl glycidyl ether. In addition, an example of an aromatic epoxy may include epoxy novolac, for example, phenol epoxy novolac and cresol epoxy novolac. Aliphatic epoxy components have one or more epoxy groups and are free of aromatic rings. The external phase can include one or more aliphatic epoxies. An example of an aliphatic epoxy may include glycidyl ether of C2-C30 alkyl; 1,2 epoxy of C3-C30 alkyl; mono or multiglycidyl ether of an aliphatic alcohol or polyol such as 1,4-butanediol, neopentyl glycol, cyclohexane dimethanol, dibromo neopentyl glycol, trimethylol propane, polytetramethylene oxide, polyethylene oxide, polypropylene oxide, glycerol, and alkoxylated aliphatic alcohols; or polyols. In one embodiment, the aliphatic epoxy may include one or more cycloaliphatic ring structures. For example, the aliphatic epoxy can have one or more cyclohexene oxide structures, for example, two cyclohexene oxide structures.

An example of an aliphatic epoxy comprising a ring structure may include hydrogenated bisphenol A diglycidyl ether, hydrogenated bisphenol F diglycidyl ether, hydrogenated bisphenol S diglycidyl ether, bis(4-hydroxycyclohexyl)methane diglycidyl ether, 2,2-bis(4-hydroxycyclohexyl)propane diglycidyl ether, 3,4-epoxycyclohexylmethyl-3,4-epoxycyclohexanecarboxylate, 3,4-epoxy-6-methylcyclohexylmethyl-3,4-epoxy-6-methylcyclohexanecarboxylate, di(3,4-epoxycyclohexylmethyl)hexanedioate, di(3,4-epoxy-6methylcyclohexylmethyl) hexanedioate, ethylenebis(3,4-epoxycyclohexanecarboxylate), ethanedioldi(3,4-epoxycyclohexylmethyl) ether, or 2-(3,4-epoxycyclohexyl-5,5-spiro-3,4-epoxy)cyclohexane-1,3-dioxane.

An exemplary multifunctional acrylic can include trimethylolpropane triacrylate, glycerol triacrylate, pentaerythritol triacrylate, methacrylate, dipentaerythritol pentaacrylate, sorbitol triacrylate, sorbital hexacrylate, or any combination thereof. In another example, an acrylic polymer can be formed from a monomer having an alkyl group having from 1-4 carbon atoms, a glycidyl group or a hydroxyalkyl group having from 1-4 carbon atoms. Representative acrylic polymers include polymethyl methacrylate, polyethyl methacrylate, polybutyl methacrylate, polyglycidyl methacrylate, polyhydroxyethyl methacrylate, polymethyl acrylate, polyethyl acrylate, polybutyl acrylate, polyglycidyl acrylate, polyhydroxyethyl acrylate and mixtures thereof.

In other embodiments, the abrasive particles may be coated with a coupling agent prior to formation of the abrasive article. Accordingly to other embodiments, the coupling agent may include an organic material. According to still other embodiments, the coupling agent may include a silane functional group. “Silane” is also known as organosilane, amino silane and methacryloxy silane. In some embodiments, the silane may include A-1100, manufactured by Momentive Silquest. See also U.S. Pat. No. 5,006,573 for other materials.

According to still other embodiments, the silane may be incorporated into formulations comprising polymerizable monomers, or monomer mixtures, having aliphatic unsaturation, and mineral fillers. In such systems, monomers are caused to polymerize in the presence of filler and coupling agent to form a solid composite. Examples of such monomers are styrene, methyl acrylate, methyl methacrylate and poly-functional acrylic monomers known in the art.

A plurality of mineral fillers, which are typically used to reinforce the above resins, may be employed. In the current context, “mineral filler” refers to inorganic material which may be of natural or synthetic origin. All these fillers have a common feature, however, in that their surfaces contain hydroxyl functionality to a greater or lesser extent. The hydroxyl groups can react with the silanol groups formed upon hydrolysis of the hydrolyzable groups X of the silane coupling agent. Notable within this general category of fillers are the siliceous materials such as glass fiber, precipitated silica, ground quartz, aluminum silicate, zirconium silicate, calcium silicate, glass micro beads, mica, asbestos, clay, vitreous enamels and ceramics. Other examples of suitable fillers include alumina, silicon carbide, and silicon whiskers. In addition to the filler, other components, such as catalysts, pigments, stabilizers and antioxidants may be included in the filled resin formulation.

According to yet another embodiment, a method of forming an abrasive article that may include coating abrasive particles with a coupling agent may include preparing a solution comprising a solvent. The solvent may include water or other solvents. The solution may include silane (i.e., a coupling agent). The silane may be in a range of about 4 vol % to about 8 vol % of a total volume of the solution. The abrasive particles may include a seeded sol-gel ceramic having a size in a range of about 600 microns to about 1200 microns. The method may include coating the abrasive particles with the solution at a ratio in a range of about 2.7 ml/lb to about 3.9 ml/lb. For example, 400 ml of solution may be used to coat about 125 lbs of abrasive particles. The method may include drying the coated abrasive particles, and then forming the abrasive article with the abrasive particles. In one example, silane has a density of about 0.95 g/ml. A quantity of about 24 ml of wet silane yields about 22.8 g of dry silane. On a quantity of 125 lb of abrasive particles, the yield is about 0.18 g/lb. The use of silane may not be detectable in the final abrasive article.

In other embodiments, solvents other that water may be used. In still other embodiments, a lower concentration of silane may be used at a higher ratio, or a higher concentration of silane may be used at a lower ratio. The silane need only be retained by the abrasive at an adequate level, so the method of application may be altered.

According to a particular embodiment, prior to formation of the abrasive article, the abrasive particles may be coated by the coupling agent at a particular ratio A_{COA}/A_{AB}, where C_{COA} is the amount of coupling agent in grams in a pre-formation mixture and A_{AB} is the amount of abrasive particles in pounds (lbs) in a pre-formation mixture. For example, according to a certain embodiment, that abrasive particles may be coated by the coupling agent at a ratio of at least about 0.1, such as, at least about 0.12, at least about 0.14, at least about 0.16, at least about 0.18, at least about 0.2, at least about 0.22, at least about 0.24, at least about 0.26 or even at least about 0.28. According to still other embodiments, the abrasive particles may be coated by the coupling agent at a ratio of not greater than about 0.3, such as, not greater than about 0.27, not greater than about 0.25, not greater than about 0.23, not greater than about 0.21, not greater than about 0.19, not greater than about 0.17, not greater than about 0.15, not greater than about 0.13 or even not greater than about 0.11.

According to still other embodiments, the bond material in the abrasive article may be essentially free of iron.

Abrasive Characteristics

Some embodiments of the abrasive article may have an average burst speed that is at least about 10% greater than that of a conventional abrasive article. The burst speed can be 15% greater, such as 20% greater, or even 25% greater. The burst speed can be in a range between any of these minimum and maximum values.

According to still other embodiments, an abrasive article formed according to embodiments described herein may include a particular G-ratio, which is the ratio of the material removal rate (MMR) of the abrasive article and the wheel wear rate (WWR) of the abrasive article. For example, an abrasive article may have a G-ratio of at least about 9.25, such as, at least about 10, at least about 10.5, at least about 11, at least about 11.5, at least about 12, at least t 12.5, at least about 13, at least about 13.5 or even at least about 14. According to still other embodiments, the abrasive article may have a G-ratio of not greater than about 15, such as, not greater than about 14.5, not greater than about 14, not greater than about 13.5, not greater than about 13, not greater than about 12.5, not greater than about 12, not greater than about 11.5, not greater than about 11.0, not greater than about 10.5, not greater than about 10.0 or even not greater than about 9.5. The G-ratio can be in a range between any of these minimum and maximum values. In other particular embodiments, an abrasive article may include a material removal rate (MMR) of at least about 30 g/min at a wheel wear rate (WWR) of 0.5 g/min.

In other embodiments, the abrasive article can include a particular wheel wear rate (WWR). For example, the abrasive article can include a WWR of not greater than about 2 g/min, such as, not greater than about 1.8 g/min or even not greater than about 1.7 g/min. According to still other embodiment, the abrasive article can include a particular standard deviation of the WWR. For example, the abrasive article can include a standard deviation of WWR of not greater than about 1 g/min, such as, not greater than about 0.75 g/min, or not greater than about 0.5 g/min, or even not greater than about 0.35 g/min.

The abrasive article also can include a particular material removal rate (MMR). For example, the abrasive article can include a MMR of at least about 48 g/min, such as, at least about 50 g/min, at least about 52 g/min, at least about 54 g/min, at least about 56 g/min, at least about 58 g/min at least about 60 g/min, or even at least about 65 g/min.

### EXAMPLES

Abrasive articles in accordance with embodiments herein were prepared and their grinding performance was compared to the performance of a conventional thin wheel abrasive article.

### Example 1

A first exemplary abrasive article formed according to an embodiment described herein (Sample 1) is a Type 27 wheel with the following overall dimensions:

Outer diameter/Axial thickness/Inner diameter: 125 mm/7 mm/22.23 mm.

Wheel Weight: 202 g+/−10 g (e.g., about 98 g in grinding layer, and about 90 g in fineback layer).

Sample 1 includes the following layers: a blotter (of 124 mm×23 mm), a fiberglass reinforcement (of 123.5 mm by 23 mm), 85 g of a fine back abrasive layer, a second fiberglass reinforcement (of 117 mm by 23 mm), 87 g of a grinding abrasive layer, a third fiberglass reinforcement (of 123.5 mm by 23 mm), and a metal ring measuring 35 mm×6.4 mm×22.35 mm.

The grinding and fine back layers include the components provided in Table 1, including the weight percent of each component based on the total weight of the mixture used to form the layers.

TABLE 1

| | |
|---|---|
| Material | vol % |

Sample 1 Grinding Layer

| | |
|---|---|
| SGA coated, crushed sol-gel, 20 grit | 42.2% |
| Durez 34127 | 12.8% |
| Durez 29346 | 21.7% |
| Lime (CaO) | 0.1% |
| Potassium | 11.2% |
| Aluminum | |
| Fluoride | |
| Porosity | 12.0% |
| Total | 100.0% |

Sample 1 Fineback Layer

| | |
|---|---|
| Brown fused alumina-46 grit | 34.6% |
| Nepthalene Syanite | 9.8% |
| Durez 34127 | 7.1% |
| Durez 29346 | 21.8% |
| Iron pyrite | 3.0% |
| Potassium | 3.7% |
| Aluminum | |
| Fluoride | |
| Porosity | 20.0% |
| Total | 100.0% |

### Example 2

Two additional exemplary abrasive articles formed according to embodiments described herein (Sample 2 and Sample 3) are also Type 27 wheels with the same layers and overall dimensions as those described in reference to Example 1. The formulations for Sample 2 and Sample 3 only differ in the type of novolac powder resin used (i.e. Sample 2 uses Durez 29346 and Sample 3 uses Durez 29722). Sample 2 and Sample 3 also include the same fine back formulation described in reference to Example 1.

TABLE 2

| | |
|---|---|
| Material | vol % |

Sample 2 Grinding Layer

| | |
|---|---|
| SGA coated, crushed sol-gel, 20 grit | 48.0% |
| Durez 34127 | 8.4% |
| Durez 29346 | 14.2% |
| Lime (CaO) | 0.1% |
| Potassium | 7.3% |
| Aluminum | |
| Fluoride | |
| Porosity | 22.0% |
| Total | 100.0% |

Sample 3 Grinding Layer

| | |
|---|---|
| SGA coated, crushed sol-gel, 20 grit | 48.0% |
| Durez 34127 | 8.4% |
| Durez 29722 | 14.2% |
| Lime (CaO) | 0.1% |
| Potassium | 7.3% |
| Aluminum | |
| Fluoride | |
| Porosity | 22.0% |
| Total | 100.0% |

FIG. 3 depicts the grinding performance of Sample 1 and Sample 2 as compared to a comparative thin wheel abrasive article (Comparative Sample 1). Comparative Sample 1 includes different abrasive particles (i.e., alumina zirconia) as compared to the abrasive particles included in Sample 1 and Samples 2 (i.e., SGA coated sol gel, 20 grit).

The grinding test for comparing the performance of Sample 1, Sample 2 and Comparative Sample 1 was conducted as follows:

Name of Test: Grind Test offhand

Machine Used: DW 831

Material: 1020 Steel Coupon or 304 SS Coupon

Grind Time: 5 mins×2

Wheel Size: 4½×¼×⅞ or 5×¼×⅞
Hold the grinder at approximately 30 degrees to metal for a type 27 wheel
Sweep the grinder across the metal, making smooth strokes across the material.
Apply enough pressure so that the amperage draw from the grinder is held at 7-8 amps.
Maintain the wheel in contact with the work piece throughout the test.
Vary the angle slightly during grinding to minimize the area of contact between the wheel and the work piece.
Grind in 5 minute cycles. Measure after each cycle.
Use 300×20×100 mm bars and grind on 300 mm face

FIG. 3 includes a graph showing the material removal rate (MMR) versus the wheel wear rate (WWR) for Sample 1, Sample 2, Comparative Sample 2. For example, plot 301 illustrates the grinding performance of Sample 1 and shows a material removal rate (MMR) of at least about 30 g/min at a wheel wear rate (WWR) of 0.5 g/min. This equates to a G-ratio (i.e. the ratio of MRR to WWR) of about 15.

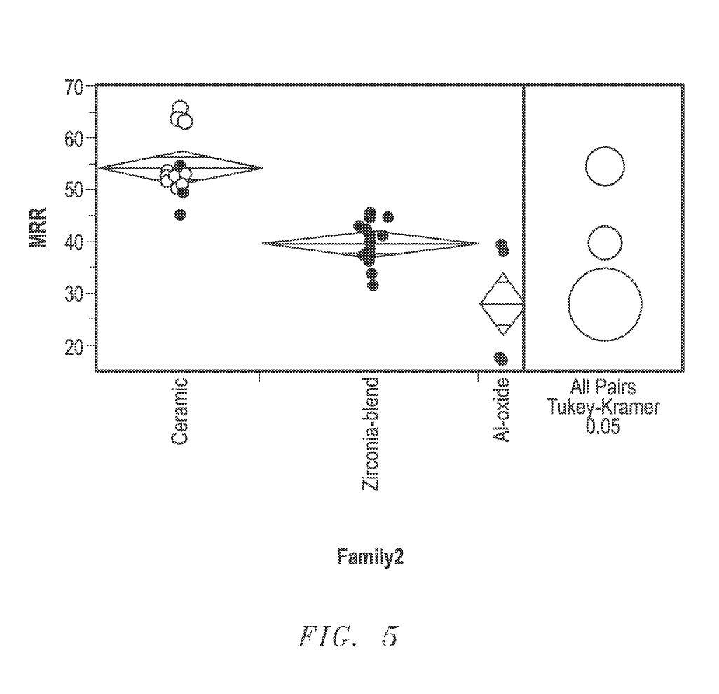

FIG. 4 includes a graph showing the material removal rate (MMR) versus the wheel wear rate (WWR) for Sample 1 and Sample 2. Based on FIG. 4, the WWR for Sample 1 is between about 1.7 g/min and about 2 g/min. Statistics for Sample 1, based on FIG. 4, appear below in Table 4.

TABLE 4

| Fit Mean: | |
|---|---|
| Mean | 1.627 |
| Std Dev [RMSE] | 0.317707 |
| Std Error | 0.071042 |

| Fit line: | |
|---|---|
| WWR = −0.70947 + 0.0497481*MRR | |
| RSquare | 0.197568 |
| RSquare Adj | 0.152988 |
| Root Mean Square Error | 0.292396 |
| Mean of Response | 1.627 |
| Observations (or Sum Wgts) | 20 |

### Example 3

The performance of an additional exemplary abrasive article formed according to embodiments described herein (Sample 4) was compared to the performance of two additional comparative samples (Comparative Sample 2 and Comparative Sample 3). Sample 4 includes ceramic abrasive particles according to embodiments described herein (i.e., SGA coated sol gel, 20 grit) while Comparative Sample 2 includes zirconia blend abrasive particles and Comparative Sample 3 includes aluminum-oxide abrasive particles.

FIG. 5 depicts a MMR for Sample 4 of at least about 48 g/min, which outperforms the MMR for Comparative Sample 2 and Comparative Sample 3.

### Example 4

Multiple examples wheels formed according to embodiments described herein were formed using a coupling agent to treat the abrasive particles (i.e. Silane Treated Samples) for comparison to example wheels formed without using a coupling agent to treat the abrasive particles (i.e., Non-Treated Comparative Samples).

As described in Table 3, the average burst speed for the Silane Treated Samples was 20,492 rpm. The burst speed for the Non-Treated Comparative Samples (i.e., samples formed without silane treatment) was 18,321 rpm. Thus, the Silane Treated Samples had an average burst speed that was about 11.8% greater than that of the Non-Treated Comparative Samples.

TABLE 3
Speed Test (18,300 RPM, 1.5x Operating Speed)

| | Silane | No Silane |
|---|---|---|
| # Wheels Pass: >18,300 RPM | 7 | 2 |
| # Wheels Fail: <18,300 RPM | 1 | 5 |

Average Burst Speed: Silane 20,492
Average Burst Speed: No Silane 18,321

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The present application represents a departure from the state of the art. Notably, the embodiments herein demonstrate improved and unexpected performance over conventional and comparative abrasive tools. While not wishing to be bound to a particular theory, it is suggested that combination of certain features including designs, processes, materials, and the like may facilitate such improvements. The combination of features can include, but is not limited to, composition of the grinding layer, fine back layer or the abrasive article as a whole (i.e., the content of abrasive particles, bond material, and porosity), the type, size and shape of the abrasive particles included in the abrasive article or any layer within the abrasive article, the composition of the bond included in the abrasive article, the pre-treatment of the abrasive particles with a coupling agent and combinations of these features. Notably these combinations of features showed improved performance as shown through, for example, the abrasive article's material removal rate, the wheel ware rate and the average burst speed.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

Item 1. An abrasive article, comprising: an abrasive body having a grinding layer, wherein the grinding layer comprises a bond, abrasive particles contained within the bond and a volumetric ratio GLV_{b}/GLVₐₚ of at least about 0.4, wherein GLV_{b} is a volume percent of bond for a total volume of the grinding layer and GLVₐₚ is a volume percent of abrasive particles for a total volume of the grinding layer; and wherein the abrasive particles comprise: seeded sol-gel ceramic; and an average particle size of at least about 600 microns.

Item 2. An abrasive article, comprising: an abrasive body having a grinding layer, wherein the grinding layer comprises a bond and abrasive particles and wherein the abrasive particles comprise: seeded sol-gel ceramic; an average particle size of at least about 600 microns; and a coupling agent comprising an organic material including a silane functional group, wherein, prior to formation of the abrasive article, the abrasive particles are coated by the coupling agent at a ratio A_{COA}/A_{AB} of at least about 0.1, wherein C_{COA} is the amount of coupling agent in grams in a pre-formation mixture and A_{AB} is the amount of abrasive particles in pounds (lbs) in the pre-formation mixture.

Item 3. The abrasive article of items 1 or 2, wherein the grinding layer comprises a volumetric ratio GLV_{b}/GLVₐₚ of at least about 0.4, wherein GLV_{b} is a volume percent of bond for a total volume of the grinding layer and GLVₐₚ is a volume percent of abrasive particles for a total volume of the grinding layer, at least about 0.45, at least about 0.5, at least about 0.55, at least about 0.6, at least about 0.65, at least about 0.7, at least about 0.75, at least about 0.8, at least about 0.85, at least about 0.9, at least about 0.95, at least about 1, at least about 1.05, at least about 1.1, at least about 1.15, at least about 1.2, at least about 1.25, at least about 1.3, at least about 1.4 and at least about 1.5.

Item 4. The abrasive article of items 1 or 2, wherein the grinding layer comprises a volumetric ratio GLV_{b}/GLVₐₚ of not greater than about 2.0, wherein GLV_{b} is a volume percent of bond for a total volume of the grinding layer and GLVₐₚ is a volume percent of abrasive particles for a total volume of the grinding layer, not greater than about 1.5, not greater than about 1.45, not greater than about 1.4, not greater than about 1.35, not greater than about 1.3, not greater than about 1.25, not greater than about 1.2, not greater than about 1.15, not greater than about 1.1, not greater than about 1.05, not greater than about 1, not greater than about 0.95, not greater than about 0.9, not greater than about 0.85, not greater than about 0.8, not greater than about 0.75, not greater than about 0.7, not greater than about 0.65 and not greater than about 0.6.

Item 5. The abrasive article of items 1 or 2, wherein the abrasive particles in the grinding layer have an average particle size of at least about 650 microns, at least about 700 microns, at least about 750 microns, at least about 800 microns, at least about 850 microns, at least about 900 microns, at least about 950 microns, at least about 1000 microns, at least about 1050 microns, at least about 1100 microns and at least about 1150 microns.

Item 6. The abrasive article of items 1 or 2, wherein the abrasive particles in the grinding layer have an average particle size of not greater than about 1200 microns, not greater than about 1150 microns, not greater than about 1100 microns, not greater than about 1050 microns, not greater than about 1000 microns, not greater than about 950 microns, not greater than about 900 microns, not greater than about 850 microns, not greater than about 800 microns, not greater than about 750 microns, not greater than about 700 microns and not greater than about 650 microns.

Item 7. The abrasive article of items 1 or 2, wherein the grinding layer comprises at least about 24 vol % bond for a total volume of the grinding layer, at least about 28 vol %, at least about 30 vol %, at least about 33 vol %, at least about 35 vol %, at least about 38 vol %, at least about 40 vol %, at least about 43 vol %, at least about 45 vol % and at leas about 48 vol %.

Item 8. The abrasive article of items 1 or 2, wherein the grinding layer comprises not greater than about 50 vol % bond for a total volume of the grinding layer, not greater than about 48 vol %, not greater than about 45 vol %, not greater than about 43 vol %, not greater than about 40 vol %, not greater than about 38 vol % and not greater than about 35 vol %.

Item 9. The abrasive article of items 1 or 2, wherein the grinding layer comprises at least about 35 vol % abrasive particles for a total volume of the grinding layer, at least about 38 vol %, at least about 40 vol %, at least about 43 vol %, at least about 45 vol %, at least about 48 vol %, at least about 50 vol %, at least about 53 vol %, at least about 55 vol % and at least about 58 vol %.

Item 10. The abrasive article of items 1 or 2, wherein the grinding layer comprises not greater than about 60 vol % abrasive particles for a total volume of the grinding layer, not greater than about 58 vol %, not greater than about 45 vol %, not greater than about 43 vol %, not greater than about 40 vol %, not greater than about 38 vol % and not greater than about 35 vol %.

Item 11. The abrasive article of items 1 or 2, wherein the grinding layer comprises at least about 10 vol % porosity for a total volume of the grinding layer, at least about 12 vol %, at least about 15 vol %, at least about 18 vol %, at least about 20 vol %, at least about 22 vol %, at least about 25 vol %, at least about 28 vol %, at least about 30 vol % and at least about 33 vol %.

Item 12. The abrasive article of items 1 or 2, wherein the grinding layer comprises not greater than about 35 vol % porosity for a total volume of the grinding layer, not greater than about 32 vol %, not greater than about 30 vol %, not greater than about 28 vol %, not greater than about 25 vol %, not greater than about 23 vol % and not greater than about 20 vol %.

Item 13. The abrasive article of items 1 or 2, wherein the grinding layer comprises at least about 0.5 vol % of a filler for a total volume of the grinding layer, at least about 1 vol %, at least about 3 vol %, at least about 5 vol %, at least about 10 vol %, at least about 15 vol % and at least about 20 vol %.

Item 14. The abrasive article of items 1 or 2, wherein the grinding layer comprises not greater than about 30 vol % of a filler for a total volume of the grinding layer, not greater than about 20 vol %, not greater than about 15 vol %, not greater than about 10 vol %, not greater than about 5 vol %, not greater than about 3 vol % and not greater than about 1 vol %.

Item 15. The abrasive article of items 1 or 2, wherein the grinding layer comprises at least about 0.5 vol % of an active filler for a total volume of the grinding layer, at least about 1 vol %, at least about 3 vol %, at least about 5 vol %, at least about 10 vol %, at least about 15 vol % and at least about 20 vol %.

Item 16. The abrasive article of items 1 or 2, wherein the grinding layer comprises not greater than about 30 vol % of an active filler for a total volume of the grinding layer, not greater than about 20 vol %, not greater than about 15 vol %, not greater than about 10 vol %, not greater than about 5 vol %, not greater than about 3 vol % and not greater than about 1 vol %.

Item 17. The abrasive article of items 1 or 2, wherein the grinding layer comprises at least about 0.5 vol % potassium fluoroborate for a total volume of the grinding layer, at least about 1 vol %, at least about 3 vol %, at least about 5 vol % and at least about 10 vol %.

Item 18. The abrasive article of items 1 or 2, wherein the grinding layer comprises not greater than about 20 vol % potassium fluoroborate for a total volume of the grinding layer, not greater than about 15 vol %, not greater than about 10 vol %, not greater than about 8 vol %, not greater than about 5 vol %, not greater than about 3 vol % and not greater than about 1 vol %.

Item 19. The abrasive article of items 1 or 2, wherein the grinding layer comprises at least about 0.5 vol % of a manganese compound for a total volume of the grinding layer, at least about 1 vol %, at least about 3 vol %, at least about 5 vol % and at least about 10 vol %.

Item 20. The abrasive article of items 1 or 2, wherein the grinding layer comprises not greater than about 20 vol % of a manganese compound for a total volume of the grinding layer, not greater than about 15 vol %, not greater than about 10 vol %, not greater than about 8 vol %, not greater than about 5 vol %, not greater than about 3 vol % and not greater than about 1 vol %.

Item 21. The abrasive article of items 1 or 2, wherein the grinding layer comprises at least about 0.5 vol % pyrite for a total volume of the grinding layer, at least about 1 vol %, at least about 3 vol %, at least about 5 vol % and at least about 10 vol %.

Item 22. The abrasive article of items 1 or 2, wherein the grinding layer comprises not greater than about 20 vol % pyrite for a total volume of the grinding layer, not greater than about 15 vol %, not greater than about 10 vol %, not greater than about 8 vol %, not greater than about 5 vol %, not greater than about 3 vol % and not greater than about 1 vol %.

Item 23. The abrasive article of items 1 or 2, wherein the grinding layer comprises at least about 0.5 vol % PAF for a total volume of the grinding layer, at least about 1 vol %, at least about 3 vol %, at least about 5 vol % and at least about 10 vol %.

Item 24. The abrasive article of items 1 or 2, wherein the grinding layer comprises not greater than about 20 vol % PAF for a total volume of the grinding layer, not greater than about 15 vol %, not greater than about 10 vol %, not greater than about 8 vol %, not greater than about 5 vol %, not greater than about 3 vol % and not greater than about 1 vol %.

Item 25. The abrasive article of items 1 or 2, further comprising a fine back layer.

Item 26. The abrasive article of item 25, wherein the fine back layer comprises a bond material and abrasive particles within the bond material.

Item 27. The abrasive article of item 26, wherein the fine back layer comprises a volumetric ratio FBLV_{b}/FBLVₐₚ of at least about 0.4, wherein FBLV_{b} is a volume percent of bond for a total volume of the fine back layer and FBLVₐₚ is a volume percent of abrasive particles for a total volume of the fine back layer, at least about 0.45, at least about 0.5, at least about 0.55, at least about 0.6, at least about 0.65, at least about 0.7, at least about 0.75, at least about 0.8, at least about 0.85, at least about 0.9, at least about 0.95, at least about 1, at least about 1.05, at least about 1.1, at least about 1.15, at least about 1.2, at least about 1.25, at least about 1.3, at least about 1.4 and at least about 1.5.

Item 28. The abrasive article of item 26, wherein the fine back layer comprises a volumetric ratio FBLV_{b}/FBLVₐₚ of not greater than about 2.0, wherein FBLV_{b} is a volume percent of bond for a total volume of the fine back layer and FBLVₐₚ is a volume percent of abrasive particles for a total volume of the fine back layer, not greater than about 1.5, not greater than about 1.45, not greater than about 1.4, not greater than about 1.35, not greater than about 1.3, not greater than about 1.25, not greater than about 1.2, not greater than about 1.15, not greater than about 1.1, not greater than about 1.05, not greater than about 1, not greater than about 0.95, not greater than about 0.9, not greater than about 0.85, not greater than about 0.8, not greater than about 0.75, not greater than about 0.7, not greater than about 0.65 and not greater than about 0.6.

Item 29. The abrasive article of item 26, wherein the abrasive particles in the fine back layer have an average particle size of at least about 200 microns, at least about 250 microns, at least about 300 microns, at least about 400 microns, at least about 450 microns, at least about 500 microns and at least about 550 microns, at least about 600 microns, at least about 700 microns, at least about 800 microns and at least about 900 microns.

Item 30. The abrasive article of item 26, wherein the abrasive particles in the fine back layer have an average particle size of not greater than about 1200 microns, not greater than about 1100 microns, not greater than about 1000 microns, not greater than about 900 microns, not greater than about 800 microns, not greater than about 700 microns, not greater than about 600 microns, not greater than about 550 microns, not greater than about 500 microns, not greater than about 450 microns, not greater than about 400 microns and not greater than about 350 microns.

Item 31. The abrasive article of item 26, wherein the fine back layer comprises at least about 20 vol % bond for a total volume of the fine back layer, at least about 23 vol %, at least about 25 vol %, at least about 28 vol %, at least about 30 vol %, at least about 35 vol %, at least about 40 vol % and at least about 45 vol %.

Item 32. The abrasive article of item 26, wherein the fine back layer comprises not greater than about 50 vol % bond for a total volume of the fine back layer, not greater than about 45 vol %, not greater than about 40 vol %, not greater than about 35 vol %, not greater than about 30 vol %, not greater than about 25 vol % and not greater than about 20 vol %.

Item 33. The abrasive article of item 26, wherein the fine back layer comprises at least about 20 vol % abrasive particles for a total volume of the fine back layer, at least about 38 vol %, at least about 40 vol %, at least about 43 vol %, at least about 45 vol %, at least about 48 vol %, at least about 50 vol %, at least about 53 vol %, at least about 55 vol % and at least about 58 vol %.

Item 34. The abrasive article of item 26, wherein the fine back layer comprises not greater than about 60 vol % abrasive particles for a total volume of the fine back layer, not greater than about 55 vol %, not greater than about 50 vol %, not greater than about 45 vol %, not greater than about 40 vol %, not greater than about 35 vol % and not greater than about 30 vol %.

Item 35. The abrasive article of item 26, wherein the fine back layer comprises at least about 10 vol % porosity for a total volume of the fine back layer, at least about 12 vol %, at least about 15 vol %, at least about 18 vol %, at least about 20 vol %, at least about 22 vol %, at least about 25 vol %, at least about 28 vol %, at least about 30 vol % and at least about 33 vol %.

Item 36. The abrasive article of item 26, wherein the fine back layer comprises not greater than about 40 vol % porosity for a total volume of the fine back layer, not greater than about 35 vol %, not greater than about 30 vol %, not greater than about 28 vol %, not greater than about 25 vol %, not greater than about 23 vol % and not greater than about 20 vol %.

Item 37. The abrasive article of item 26, wherein the fine back layer comprises at least about 0.5 vol % of a filler for a total volume of the fine back layer, at least about 1 vol %, at least about 3 vol %, at least about 5 vol %, at least about 10 vol %, at least about 15 vol % and at least about 20 vol %.

Item 38. The abrasive article of item 26, wherein the fine back layer comprises not greater than about 30 vol % of a filler for a total volume of the fine back layer, not greater than about 20 vol %, not greater than about 15 vol %, not greater than about 10 vol %, not greater than about 5 vol %, not greater than about 3 vol % and not greater than about 1 vol %.

Item 39. The abrasive article of item 26, wherein the fine back layer comprises at least about 0.5 vol % of an active filler for a total volume of the fine back layer, at least about 1 vol %, at least about 3 vol %, at least about 5 vol %, at least about 10 vol %, at least about 15 vol % and at least about 20 vol %.

Item 40. The abrasive article of item 26, wherein the fine back layer comprises not greater than about 30 vol % of an active filler for a total volume of the fine back layer, not greater than about 20 vol %, not greater than about 15 vol %, not greater than about 10 vol %, not greater than about 5 vol %, not greater than about 3 vol % and not greater than about 1 vol %.

Item 41. The abrasive article of item 26, wherein the fine back layer comprises at least about 0.5 vol % potassium fluoroborate for a total volume of the fine back layer, at least about 1 vol %, at least about 3 vol %, at least about 5 vol % and at least about 10 vol %.

Item 42. The abrasive article of item 26, wherein the fine back layer comprises not greater than about 20 vol % potassium fluoroborate for a total volume of the fine back layer, not greater than about 15 vol %, not greater than about 10 vol %, not greater than about 8 vol %, not greater than about 5 vol %, not greater than about 3 vol % and not greater than about 1 vol %.

Item 43. The abrasive article of item 26, wherein the fine back layer comprises at least about 0.5 vol % of a manganese compound for a total volume of the fine back layer, at least about 1 vol %, at least about 3 vol %, at least about 5 vol % and at least about 10 vol %.

Item 44. The abrasive article of item 26, wherein the fine back layer comprises not greater than about 20 vol % of a manganese compound for a total volume of the fine back layer, not greater than about 15 vol %, not greater than about 10 vol %, not greater than about 8 vol %, not greater than about 5 vol %, not greater than about 3 vol % and not greater than about 1 vol %.

Item 45. The abrasive article of item 26, wherein the fine back layer comprises at least about 0.5 vol % pyrite for a total volume of the fine back layer, at least about 1 vol %, at least about 3 vol %, at least about 5 vol % and at least about 10 vol %.

Item 46. The abrasive article of items 1 or 2, wherein the abrasive layer comprises not greater than about 20 vol % pyrite for a total volume of the fine back layer, not greater than about 15 vol %, not greater than about 10 vol %, not greater than about 8 vol %, not greater than about 5 vol %, not greater than about 3 vol % and not greater than about 1 vol %.

Item 47. The abrasive article of item 26, wherein the fine back layer comprises at least about 0.5 vol % PAF for a total volume of the fine back layer, at least about 1 vol %, at least about 3 vol %, at least about 5 vol % and at least about 10 vol %.

Item 48. The abrasive article of item 26, wherein the fine back layer comprises not greater than about 20 vol % PAF for a total volume of the abrasive layer, not greater than about 15 vol %, not greater than about 10 vol %, not greater than about 8 vol %, not greater than about 5 vol %, not greater than about 3 vol % and not greater than about 1 vol %.

Item 49. The abrasive article of item 26, wherein the abrasive article comprises a volumetric ratio AAV_{b}/AAVₐₚ of at least about 0.4, wherein AAV_{b} is a volume percent of bond for a total volume of the abrasive article and AAVₐₚ is a volume percent of abrasive particles for a total volume of the abrasive article, at least about 0.45, at least about 0.5, at least about 0.55, at least about 0.6, at least about 0.65, at least about 0.7, at least about 0.75, at least about 0.8, at least about 0.85, at least about 0.9, at least about 0.95, at least about 1, at least about 1.05, at least about 1.1, at least about 1.15, at least about 1.2, at least about 1.25, at least about 1.3, at least about 1.4 and at least about 1.5.

Item 50. The abrasive article of item 26, wherein the abrasive article comprises a volumetric ratio AAV_{b}/AAVₐₚ of not greater than about 2.0, wherein AAV_{b} is a volume percent of bond for a total volume of the abrasive article and AAVₐₚ is a volume percent of abrasive particles for a total volume of the abrasive article, not greater than about 1.5, not greater than about 1.45, not greater than about 1.4, not greater than about 1.35, not greater than about 1.3, not greater than about 1.25, not greater than about 1.2, not greater than about 1.15, not greater than about 1.1, not greater than about 1.05, not greater than about 1, not greater than about 0.95, not greater than about 0.9, not greater than about 0.85, not greater than about 0.8, not greater than about 0.75, not greater than about 0.7, not greater than about 0.65 and not greater than about 0.6.

Item 51. The abrasive article of item 26, wherein the abrasive particles in the abrasive article have an average particle size of at least about 200 microns, at least about 250 microns, at least about 300 microns, at least about 400 microns, at least about 450 microns, at least about 500 microns and at least about 550 microns, at least about 600 microns, at least about 700 microns, at least about 800 microns and at least about 900 microns.

Item 52. The abrasive article of item 26, wherein the abrasive particles in the abrasive article have an average particle size of not greater than about 1200 microns, not greater than about 1100 microns, not greater than about 1000 microns, not greater than about 900 microns, not greater than about 800 microns, not greater than about 700 microns, not greater than about 600 microns, not greater than about 550 microns, not greater than about 500 microns, not greater than about 450 microns, not greater than about 400 microns and not greater than about 350 microns.

Item 53. The abrasive article of item 26, wherein the abrasive article comprises at least about 20 vol % for a total volume of the abrasive article, at least about 23 vol %, at least about 25 vol %, at least about 28 vol %, at least about 30 vol %, at least about 35 vol %, at least about 40 vol % and at least about 45 vol %.

Item 54. The abrasive article of item 26, wherein the abrasive article comprises not greater than about 50 vol % bond for a total volume of the abrasive article, not greater than about 45 vol %, not greater than about 40 vol %, not greater than about 35 vol %, not greater than about 30 vol %, not greater than about 25 vol % and not greater than about 20 vol %.

Item 55. The abrasive article of item 26, wherein the abrasive article comprises at least about 20 vol % abrasive particles for a total volume of the abrasive article, at least about 38 vol %, at least about 40 vol %, at least about 43 vol %, at least about 45 vol %, at least about 48 vol %, at least about 50 vol %, at least about 53 vol %, at least about 55 vol % and at least about 58 vol %.

Item 56. The abrasive article of item 26, wherein the abrasive article comprises not greater than about 60 vol % abrasive particles for a total volume of the abrasive article, not greater than about 55 vol %, not greater than about 50 vol %, not greater than about 45 vol %, not greater than about 40 vol %, not greater than about 35 vol % and not greater than about 30 vol %.

Item 57. The abrasive article of item 26, wherein the abrasive article comprises at least about 10 vol % porosity for a total volume of the abrasive article, at least about 12 vol %, at least about 15 vol %, at least about 18 vol %, at least about 20 vol %, at least about 22 vol %, at least about 25 vol %, at least about 28 vol %, at least about 30 vol % and at least about 33 vol %.

Item 58. The abrasive article of item 26, wherein the abrasive article comprises not greater than about 40 vol % porosity for a total volume of the abrasive article, not greater than about 35 vol %, not greater than about 30 vol %, not greater than about 28 vol %, not greater than about 25 vol %, not greater than about 23 vol % and not greater than about 20 vol %.

Item 59. The abrasive article of item 26, wherein the abrasive article comprises at least about 0.5 vol % of a filler for a total volume of the abrasive article, at least about 1 vol %, at least about 3 vol %, at least about 5 vol %, at least about 10 vol %, at least about 15 vol % and at least about 20 vol %.

Item 60. The abrasive article of item 26, wherein the abrasive article comprises not greater than about 30 vol % of a filler for a total volume of the abrasive article, not greater than about 20 vol %, not greater than about 15 vol %, not greater than about 10 vol %, not greater than about 5 vol %, not greater than about 3 vol % and not greater than about 1 vol %.

Item 61. The abrasive article of item 26, wherein the abrasive article comprises at least about 0.5 vol % of an active filler for a total volume of the abrasive article, at least about 1 vol %, at least about 3 vol %, at least about 5 vol %, at least about 10 vol %, at least about 15 vol % and at least about 20 vol %.

Item 62. The abrasive article of item 26, wherein the abrasive article comprises not greater than about 30 vol % of an active filler for a total volume of the abrasive article, not greater than about 20 vol %, not greater than about 15 vol %, not greater than about 10 vol %, not greater than about 5 vol %, not greater than about 3 vol % and not greater than about 1 vol %.

Item 63. The abrasive article of item 26, wherein the abrasive article comprises at least about 0.5 vol % potassium fluoroborate for a total volume of the abrasive article, at least about 1 vol %, at least about 3 vol %, at least about 5 vol % and at least about 10 vol %.

Item 64. The abrasive article of item 26, wherein the abrasive article comprises not greater than about 20 vol % potassium fluoroborate for a total volume of the abrasive article, not greater than about 15 vol %, not greater than about 10 vol %, not greater than about 8 vol %, not greater than about 5 vol %, not greater than about 3 vol % and not greater than about 1 vol %.

Item 65. The abrasive article of item 26, wherein the abrasive article comprises at least about 0.5 vol % of a manganese compound for a total volume of the abrasive article, at least about 1 vol %, at least about 3 vol %, at least about 5 vol % and at least about 10 vol %.

Item 66. The abrasive article of item 26, wherein the abrasive article comprises not greater than about 20 vol % of a manganese compound for a total volume of the abrasive article, not greater than about 15 vol %, not greater than about 10 vol %, not greater than about 8 vol %, not greater than about 5 vol %, not greater than about 3 vol % and not greater than about 1 vol %.

Item 67. The abrasive article of item 26, wherein the abrasive article comprises at least about 0.5 vol % pyrite for a total volume of the abrasive article, at least about 1 vol %, at least about 3 vol %, at least about 5 vol % and at least about 10 vol %.

Item 68. The abrasive article of items 1 or 2, wherein the abrasive layer comprises not greater than about 20 vol % pyrite for a total volume of the abrasive article, not greater than about 15 vol %, not greater than about 10 vol %, not greater than about 8 vol %, not greater than about 5 vol %, not greater than about 3 vol % and not greater than about 1 vol %.

Item 69. The abrasive article of item 26, wherein the abrasive article comprises at least about 0.5 vol % PAF for a total volume of the abrasive article, at least about 1 vol %, at least about 3 vol %, at least about 5 vol % and at least about 10 vol %.

Item 70. The abrasive article of item 26, wherein the abrasive article comprises not greater than about 20 vol % PAF for a total volume of the abrasive layer, not greater than about 15 vol %, not greater than about 10 vol %, not greater than about 8 vol %, not greater than about 5 vol %, not greater than about 3 vol % and not greater than about 1 vol %.

Item 71. The abrasive article of items 1 or 2, wherein, prior to formation of the abrasive article, the abrasive particles are coated by the coupling agent at a ratio A_{COA}/A_{AB} of at least about 0.1 g/lb, wherein C_{COA} is the amount of coupling agent in grams in a pre-formation mixture and A_{AB} is the amount of abrasive particles in pounds (lbs) in a pre-formation mixture, at least about 0.12, at least about 0.14, at least about 0.16, at least about 0.18, at least about 0.2, at least about 0.22, at least about 0.24, at least about 0.26 and at least about 0.28.

Item 72. The abrasive article of items 1 or 2, wherein, prior to formation of the abrasive article, the abrasive particles are coated by the coupling agent at a ratio A_{COA}/A_{AB} of not greater than about 0.3 g/lb, wherein C_{COA} is the amount of coupling agent in grams in a pre-formation mixture and A_{AB} is the amount of abrasive particles in pounds (lbs) in a pre-formation mixture, not greater than about 0.27 g/lb, not greater than about 0.25 g/lb, not greater than about 0.23 g/lb, not greater than about 0.21 g/lb, not greater than about 0.19 g/lb, not greater than about 0.17 g/lb, not greater than about 0.15 g/lb, not greater than about 0.13 g/lb and not greater than about 0.11 g/lb.

Item 73. The abrasive article of items 1 or 2, wherein the abrasive article comprises a material removal rate (MMR) of at least about 30 g/min at a wheel wear rate (WWR) of 0.5 g/min.

Item 74. The abrasive article of items 1 or 2, wherein the abrasive article comprises a G-ratio of at least about 9.25, at least about 10, at least about 10.5, at least about 11, at least about 11.5, at least about 12, at least t 12.5, at least about 13, at least about 13.5 and at least about 14.

Item 75. The abrasive article of items 1 or 2, wherein the abrasive article comprises a G-ratio of not greater than about 15, not greater than about 14.5, not greater than about 14, not greater than about 13.5, not greater than about 13, not greater than about 12.5, not greater than about 12, not greater than about 11.5, not greater than about 11.0, not greater than about 10.5, not greater than about 10.0 and not greater than about 9.5.

Item 76. The abrasive article of items 1 or 2, wherein the abrasive article comprises a wheel wear rate (WWR) of not greater than about 2 g/min, not greater than about 1.8 g/min, or not greater than about 1.7 g/min.

Item 77. The abrasive article of items 1 or 2, wherein the abrasive article comprises a wheel wear rate (WWR), and a standard deviation of the WWR is not greater than about 1 g/min, not greater than about 0.75 g/min, or not greater than about 0.5 g/min, or not greater than about 0.35 g/min.

Item 78. The abrasive article of items 1 or 2, wherein the abrasive article comprises a material removal rate (MMR) of at least about 48 g/min.

Item 79. The abrasive article of items 1 or 2, wherein the abrasive particles comprise seeded sol-gel ceramic, consist essentially of seeded sol-gel ceramic, or are 100% seeded sol-gel ceramic.

Item 80. The abrasive article of items 1 or 2, further comprising shaped abrasive particles, wherein the shaped abrasive particles are disposed in a grinding layer of the abrasive body, wherein the shaped abrasive particles are disposed in a fine back layer of the abrasive body.

Item 81. The abrasive article of item 81, wherein the shaped abrasive particles comprise a well-defined and regular arrangement of edges and sides, thus defining an identifiable shape.

Item 82. The abrasive article of item 82, wherein the shaped abrasive particles comprise a polygonal shape as viewed in a plane defined by any two dimensions of length, width, and height

Item 83. The abrasive article of item 83, wherein the shaped abrasive particles comprise triangular shape, quadrilateral shape, a rectangular shape, a square shape, a trapezoidal shape, a parallelogram shape, a pentagon shape, a hexagon shape, a heptagon shape, an octagon shape, a nonagon shape, a decagon shape.

Item 84. The abrasive article of item 81, wherein the shaped abrasive particles comprise curved edges.

Item 85. The abrasive article of items 1 or 2, wherein the abrasive particles are randomly shaped particles.

Item 86. The abrasive article of items 1 or 2, wherein the bond is essentially free of iron.

Item 87. The abrasive article of items 1 or 2, wherein the bond in the grinding layer comprises at least about 50 vol % resin for a total volume of the bond in the grinding layer, at least about 55 vol % resin, at least about 60 vol % resin, at least about 65 vol % resin, at least about 70 vol % resin and at least about 75 vol % resin.

Item 88. The abrasive article of items 1 or 2, wherein the bond in the grinding layer comprises not greater than about 80 vol % resin for the total volume of the bond in the grinding layer, not greater than about 75 vol % resin, not greater than about 70 vol % resin, not greater than about 65 vol % resin and not greater than about 60 vol % resin.

Item 89. The abrasive article of item 26, wherein the bond in the fine back layer comprises at least about 50 vol % resin for a total volume of the bond in the fine back layer, at least about 55 vol % resin, at least about 60 vol % resin, at least about 65 vol % resin, at least about 70 vol % resin and at least about 75 vol % resin.

Item 90. The abrasive article of item 26, wherein the bond in the fine back layer comprises not greater than about 80 vol % resin for the total volume of the bond in the fine back layer, not greater than about 75 vol % resin, not greater than about 70 vol % resin, not greater than about 65 vol % resin and not greater than about 60 vol % resin.

Item 91. The abrasive article of item 26, wherein the bond in the abrasive article comprises at least about 50 vol % resin for a total volume of the bond in the abrasive article, at least about 55 vol % resin, at least about 60 vol % resin, at least about 65 vol % resin, at least about 70 vol % resin and at least about 75 vol % resin.

Item 92. The abrasive article of item 26, wherein the bond in the abrasive article comprises not greater than about 80 vol % resin for the total volume of the bond in the abrasive article, not greater than about 75 vol % resin, not greater than about 70 vol % resin, not greater than about 65 vol % resin and not greater than about 60 vol % resin.

What is claimed is:

1. An abrasive article, comprising:
an abrasive body having a grinding layer, wherein the grinding layer comprises a bond, abrasive particles contained within the bond and a volumetric ratio GLV_{b}/GLVₐₚ of at least about 0.4, wherein GLV_{b} is a volume percent of bond for a total volume of the grinding layer and GLVₐₚ is a volume percent of abrasive particles for a total volume of the grinding layer; and
wherein the abrasive particles comprise:
seeded sol-gel ceramic; and
an average particle size of at least about 600 microns.

2. The abrasive article of claim 1, wherein the grinding layer comprises a volumetric ratio GLV_{b}/GLVₐₚ of at least about 0.5 and not greater than about 2.0, wherein GLV_{b} is a volume percent of bond for a total volume of the grinding layer and GLVₐₚ is a volume percent of abrasive particles for a total volume of the grinding layer.

3. The abrasive article of claim 1, wherein the abrasive particles in the grinding layer have an average particle size of at least about 650 microns and not greater than about 1200 microns.

4. The abrasive article of claim 1, wherein the grinding layer comprises at least about 24 vol % bond for a total volume of the grinding layer and not greater than about 50 vol % bond for a total volume of the grinding layer.

5. The abrasive article of claim 1, wherein the grinding layer comprises at least about 35 vol % abrasive particles for a total volume of the grinding layer and not greater than about 60 vol % abrasive particles for a total volume of the grinding layer.

6. The abrasive article of claim 1, wherein the grinding layer comprises at least about 10 vol % porosity for a total volume of the grinding layer and not greater than about 35 vol % porosity for a total volume of the grinding layer.

7. The abrasive article of claim 1, wherein the grinding layer comprises at least about 0.5 vol % of a filler for a total volume of the grinding layer not greater than about 30 vol % of a filler for a total volume of the grinding layer.

8. The abrasive article of claim 1, wherein the grinding layer comprises at least about 0.5 vol % of an active filler for a total volume of the grinding layer and not greater than about 30 vol % of an active filler for a total volume of the grinding layer.

9. The abrasive article of claim 1, further comprising a fine back layer, wherein the fine back layer comprises a bond material and abrasive particles within the bond material.

10. The abrasive article of claim 9, wherein the fine back layer comprises a volumetric ratio FBLV_{b}/FBLVₐₚ of at least about 0.4 and not greater than about 2.0, wherein FBLV_{b} is a volume percent of bond for a total volume of the fine back layer and FBLVₐₚ is a volume percent of abrasive particles for a total volume of the fine back layer.

11. The abrasive article of claim 9, wherein the abrasive article comprises a volumetric ratio AAV_{b}/AAVₐₚ of at least about 0.4 and not greater than about 2.0, wherein AAV_{b} is a volume percent of bond for a total volume of the abrasive article and AAVₐₚ is a volume percent of abrasive particles for a total volume of the abrasive article.

12. The abrasive article of claim 1, wherein the abrasive article comprises a G-ratio of at least about 9.25.

13. The abrasive article of claim 1, wherein the abrasive particles consist essentially of seeded sol-gel ceramic.

14. The abrasive article of claim 1, wherein the abrasive particles are randomly shaped particles.

15. An abrasive article, comprising:
an abrasive body having a grinding layer, wherein the grinding layer comprises a bond and abrasive particles and wherein the abrasive particles comprise:
seeded sol-gel ceramic;
an average particle size of at least about 600 microns; and
a coupling agent comprising an organic material including a silane functional group, wherein, prior to formation of the abrasive article, the abrasive particles are coated by the coupling agent at a ratio A_{COA}/A_{AB} of at least about 0.1, wherein C_{COA} is the amount of coupling agent in grams in a pre-formation mixture and A_{AB} is the amount of abrasive particles in pounds (lbs) in the pre-formation mixture.

16. The abrasive article of claim 15, wherein the grinding layer comprises a volumetric ratio GLV_{b}/GLVₐₚ of at least about 0.4 and not greater than about 2.0, wherein GLV_{b} is a volume percent of bond for a total volume of the grinding layer and GLVₐₚ is a volume percent of abrasive particles for a total volume of the grinding layer.

17. The abrasive article of claim 15, wherein the grinding layer comprises at least about 24 vol % bond for a total volume of the grinding layer and not greater than about 50 vol % bond for a total volume of the grinding layer.

18. The abrasive article of claim 15, wherein the grinding layer comprises at least about 35 vol % abrasive particles for a total volume of the grinding layer and not greater than about 60 vol % abrasive particles for a total volume of the grinding layer.

19. The abrasive article of claim 15, wherein the abrasive article comprises a wheel wear rate (WWR) of not greater than about 2 g/min.

20. A method of forming an abrasive article, comprising:
preparing a solution comprising water and silane, wherein the silane comprises about 4 vol % to about 8 vol % of a total volume of the solution;
providing abrasive particles comprising a seeded sol-gel ceramic having an average particle size of at least about 600 microns and not greater than about 1200 microns;
coating the abrasive particles with the solution at a ratio in a range of about 2.7 ml/lb to about 3.9 ml/lb;
drying the coated abrasive particles; and then
forming the abrasive article with the abrasive particles.
